(19) United States
(12) Patent Application Publication
(10) Pub. No.: US 2021/0372539 A1
(43) Pub. Date: Dec. 2, 2021

(54) VACUUM ADAPTER APPARATUS, SYSTEMS, AND RELATED METHODS FOR USE WITH INFLATABLE STRUCTURES HAVING RELIEF VALVES

(71) Applicant: Navatek LLC, Honolulu, HI (US)

(72) Inventors: Collin WESTON, Honolulu, HI (US); Michael ROBER, Portland, ME (US)

(73) Assignee: Navatek LLC, Honolulu, HI (US)

(21) Appl. No.: 16/890,667

(22) Filed: Jun. 2, 2020

(51) Int. Cl. F16K 15/20

(52) U.S. Cl. CPC F16K 15/20; F16K 15/148

(57) ABSTRACT

Vacuum adapter apparatus, systems, and related methods for use with inflatable structures having relief valves are disclosed. An example vacuum adapter for a relief valve of an inflatable structure includes a first end portion adapted to connect with the relief valve, a second end portion adapted to connect with a vacuum fluid line, an intermediate portion coupled between the first and second end portions, a vacuum chamber extending through the intermediate portion between the first and second end portions such that a fluid is conveyable through the vacuum chamber from the relief valve to the vacuum fluid line, and a fluid seal positioned on the first end portion. The fluid seal is configured to engage an outlet portion of the relief valve to maintain a negative gauge pressure in the vacuum chamber that causes the relief valve to open during a deflating process of the inflatable structure.

### FIELD OF THE DISCLOSURE

This disclosure relates generally to adapters and, more particularly, to vacuum adapter apparatus, systems, and related methods for use with inflatable structures having relief valves.

### BACKGROUND

Inflatable structures are utilized in a wide-range of applications. For example, an inflatable vessel, such as a watercraft, can be inflated to provide buoyancy to occupants on a body of water and then deflated after deployment for stowage. To facilitate such inflation and deflation, inflatable structures typically employ one or more fluid valves.

### SUMMARY

An exemplary vacuum adapter for a relief valve of an inflatable structure can include a first end portion adapted to connect with the relief valve and a second end portion adapted to connect with a vacuum fluid line. The vacuum adapter can also include an intermediate portion coupled between the first and second end portions. A vacuum chamber can extend through the intermediate portion between the first and second end portions, such that a fluid is conveyable through the vacuum chamber from the relief valve to the vacuum fluid line. The vacuum adapter can also include a fluid seal that is positioned on the first end portion. The fluid seal is configured to engage an outlet portion of the relief valve to maintain a negative pressure in the vacuum chamber that causes the relief valve to open during a deflating process of the inflatable structure.

Another exemplary vacuum adapter can include a body configured to fluidly couple a vacuum fluid line to a fluid valve of an inflatable structure. The vacuum adapter can also include a fluid inlet positioned at a first end of the body to receive an outlet portion of the fluid valve that is external to the inflatable structure. The vacuum adapter can also include a fluid outlet positioned at a second end of the body to receive a vacuum fluid line. A vacuum chamber can be included within the body and in fluid communication with the fluid inlet and the fluid outlet. The vacuum adapter is configured to engage the outlet portion to form a seal around the outlet portion that maintains a negative gauge pressure in the vacuum chamber causing the fluid valve to open for a time interval.

An exemplary apparatus can include a vacuum adapter configured to couple between a vacuum fluid line and a pressure relief valve of an inflatable structure. The vacuum adapter can include a body that defines a vacuum chamber to convey a fluid from the pressure relief valve to the vacuum fluid line during a vacuuming process of the inflatable structure. The apparatus can also include means for forming an airtight seal around an outlet portion of the pressure relief valve.

The foregoing paragraphs have been provided by way of general introduction, and are not intended to limit the scope of the following claims.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic illustration of an exemplary system that includes an inflatable structure and an adapter in accordance with the teachings of this disclosure;

FIGS. 2A, 2B, and 2C are detailed views of the inflatable structure of FIG. 1 and show different states thereof;

FIGS. 3A, 3B, 3C, 3D, 3D, and 3E are detailed views of the adapter of FIG. 1 and show an implementation thereof in accordance with the teachings of this disclosure;

FIGS. 4A, 4B, 4C, and 4D are other detailed views of the adapter of FIG. 1 and show an additional implementation thereof in accordance with the teachings of this disclosure; and

FIGS. 5A, 5B, 5C, and 5D are other detailed views of the adapter of FIG. 1 and show an additional implementation thereof in accordance with the teachings of this disclosure; and

FIG. 6 is a flowchart representative of an exemplary method that can be executed to implement one or more examples disclosed herein.

The figures are not to scale. In general, the same reference numbers will be used throughout the drawing(s) and accompanying written description to refer to the same or like parts.

### DETAILED DESCRIPTION

Inflatable structures typically utilize an inflation/deflation valve (i.e., a dump valve) for adding or removing air from each associated air chamber. Additionally, a pressure relief valve (PRV) (sometimes referred to as a relief valve) is often utilized to prevent damage and control operating pressure within the chamber, drop-stitch panel, or air cell. The combination of these two valves allows for easy inflation, and a substantial amount of the air can be removed when the structure or vessel is deflated for stowage. However, when a substantial negative gauge pressure (e.g., a vacuum) is created within the chamber to reduce the stowage size or the buoyancy of the deflated chamber, air can leak back into the chamber via the inflation/deflation valve due to the pressure gradient across the valve being higher than the closing force from an internal spring of the valve. Thus, such conventional inflation/deflation valves, when used in connection with a vacuum system or pump, prevent the creation of a substantial negative gauge pressure within an air chamber because an inflation/deflation valve will leak air if an ambient air pressure exerts a force on the valve that is greater than the internal valve spring. Consequently, residual air will always be present when vacuuming air out of a typical air chamber, drop-stitch panel, or air cell, in part due to the vacuum overcoming the spring force of the inflation/deflation valve.

Aspects of the disclosure provide vacuum adapter apparatus, systems, and related methods for use with inflatable structures having relief valves. Examples disclosed herein provide an effective, low-cost solution to advantageously connect a fluid line (e.g., a low-pressure fluid line) to a relief valve and the like of an inflatable structure and expel a fluid from the inflatable structure via the relief valve. The inflatable structure can be, for example, one of a vessel (e.g., a watercraft), a support structure, and the like. Some disclosed examples provide an exemplary vacuum adapter including a body adapted to fluidly couple the fluid line to the relief valve. The relief valve includes an outlet portion external to the inflatable structure and/or exposed to an external environment, which can receive the body or a fluid inlet thereon. In some embodiments, the adapter is removably attachable to the relief valve, for example, such that a user can easily couple the body to the outlet portion and decouple the body from the outlet portion after use.

The disclosed adapter can include a vacuum chamber internal to the body and extending through the body from the fluid inlet to a fluid outlet on the body. The vacuum chamber is configured to convey, at a relatively low pressure, the fluid from the relief valve to the fluid line during a vacuuming process of the inflatable structure. For example, the fluid line can be connected to a vacuum pump configured to create a certain negative gauge pressure (e.g., a vacuum) within the fluid line and the vacuum chamber (i.e., outside of the relief valve) that causes the relief valve to open. More particularly, the disclosed adapter or a component thereof is configured to engage the outlet portion of the relief valve to maintain the negative gauge pressure in the vacuum chamber during the vacuuming process, thereby opening the relief valve and/or keeping the relief valve open (e.g., temporarily or for a time interval) to allow a certain amount of the fluid to be pulled out of the inflatable structure through the relief valve.

Generally speaking, the relief valve (sometimes referred to as a PRV) is designed to open and release pressure from inside an inflatable structure when the pressure inside the inflatable structure exceeds a threshold. In other words, the PRV is configured to open and/or remain open when a pressure gradient force applied to the relief valve exceeds a threshold or target force (e.g., a closing force) associated with changing a position of the relief valve. The pressure gradient force is substantially defined by (a) a fluid pressure internal to relief valve (e.g., a fluid pressure in the inflatable structure) and (b) a fluid pressure external to the relief valve (e.g., the negative gauge pressure in the vacuum chamber). When the relief valve is open during the vacuuming process, the fluid in the inflatable structure is enabled to flow across the relief valve to decrease the fluid pressure in the inflatable structure and, consequently decrease associated stowage size and/or buoyancy. In particular, the relief valve is configured to close and/or remain closed when the pressure gradient force falls below the target force, thereby preventing fluid from flowing across the relief valve back into the inflatable structure to maintain a deflated state of the inflatable structure after the vacuuming process is complete.

Accordingly, in some embodiments, when the negative gauge pressure is created in the vacuum chamber, the pressure gradient force applied to the relief valve is initially above the target force and remains above the target force for a time interval during which the pressure gradient force decreases and approaches the target force resulting from deflation of the inflatable structure. In such embodiments, the adapter enables the relief valve to remain open during the vacuuming process, for example, until a certain pressure differential is achieved. Alternatively, the relief valve remains open during the vacuuming process until a user detaches the adapter from the relief valve or deactivates the vacuum pump (e.g., prior to achieving the certain pressure differential). By utilizing the disclosed adapter to vacuum the fluid out of the inflatable structure through the relief valve in such a manner (instead of through an inflation/deflation valve), the inflatable structure can be substantially more compact and less buoyant when stowed with less residual fluid therein. Additionally, to further ensure the state of the inflatable structure is maintained, an inflation/deflation valve of the inflatable structure can be sealed off via a cap to prevent the fluid from leaking back into the inflatable structure through the inflation/deflation valve after the vacuuming process is complete.

In some embodiments, the disclosed adapter hermetically seals off the vacuum chamber when coupled between the fluid line and the outlet portion of the relief valve. For example, the adapter can be configured to create an airtight seal around the outlet portion that prevents external fluids (e.g., water, ambient air, and the like) from leaking into the vacuum chamber during the vacuuming process. In such embodiments, the adapter provides such a tight closure by utilizing existing threads of the relief valve. Additionally or alternatively, in such embodiments, the airtight seal is facilitated by a compliant nature of adapter or part thereof. For example, at least a portion of the adapter can be constructed of one or more materials that are substantially flexible and/or elastic such as, for example, thermoplastic polyurethane (TPU). Accordingly, in some such embodiments, the disclosed adapter includes one or more exemplary fluid seals (e.g., washers, O-rings, or other mechanical fluid seals) that can be implemented by features of the adapter. For example, a disclosed fluid seal can include an elastic section of the body defining an aperture in which the outlet portion is insertable. Continuing with this example, the outlet portion can be inserted in the aperture, thereby expanding the elastic section and causing the elastic section to tightly grip the outlet portion or one or more flanges on the outlet portion. In another example, an additional disclosed fluid seal can include threads (e.g., inner threads or outer threads) of the adapter that are coupled to the adapter body. Continuing with this example, the adapter body can be screwed into the outlet portion via the threads and respective threads (e.g., inner threads or outer threads) on the outlet portion. Such advantageous features of the adapter are discussed in greater detail below in connection with the figures.

Thus, the examples disclosed herein advantageously utilize inherent characteristics of relief valves (and the like) to allow one or more users to effectively vacuum a fluid out of an inflatable structure having such a fluid valve. Adapters disclosed herein are sometimes referred to as vacuum adapters for relief valves (VARVs). When used in connection with a suitable vacuum system and fluid valve, a disclosed adapter serves as a low-cost solution to reducing stowage size and/or residual buoyance of such inflatable structures. In particular, such an adapter allows for a high quality vacuum to be achieved, for example, while using commercial off-the-shelf (COTS) valve hardware such as COTS high-pressure inflation/deflation valves and/or PRVs. Further, rapid prototyping can be employed to create a unique adapter for each type of COTS PRV. As a result, the adapters disclosed herein can be designed in accordance with a wide-range of valve geometry and can be advantageously utilized in a wide-range of applications.

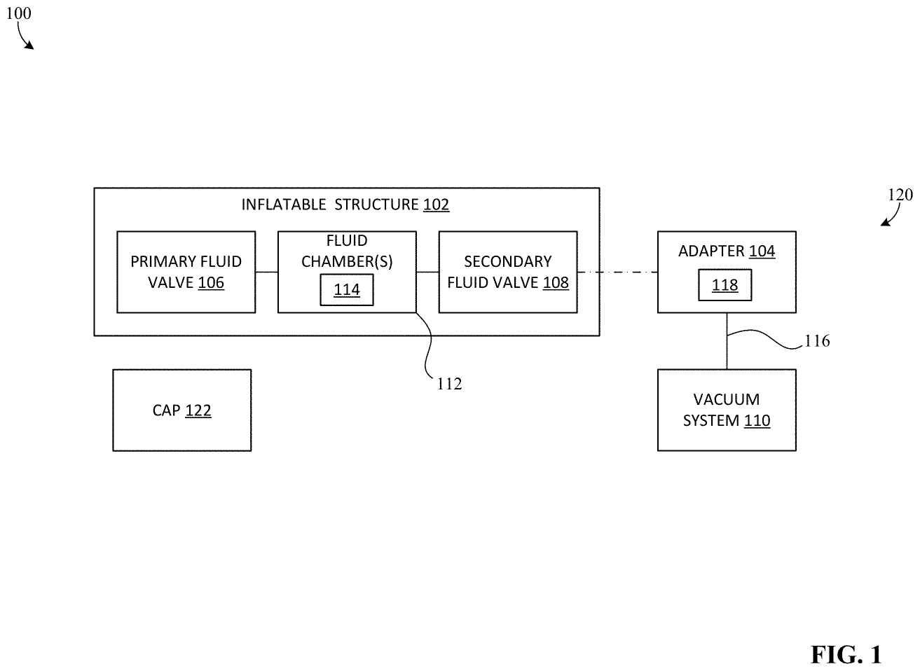

FIG. 1 is a schematic illustration of an exemplary system 100 that includes an inflatable structure 102 and an adapter 104 that is configured to attach to a fluid valve of the inflatable structure 102. According to the illustrated example of FIG. 1, the system 100 also includes one or more fluid valves 106 and 108 that can be operatively coupled to the inflatable structure 102, two of which are shown in this example. As shown, the exemplary system 100 of FIG. 1 includes a first or primary fluid valve (e.g., an inflation/deflation valve) 106 and a second or secondary fluid valve (e.g., relief valve, such as a spring-loaded PRV) 108. In particular, the vacuum adapter 104 of FIG. 1 provides an advantageous fluid connection between a component (e.g., a fluid line) of a vacuum system 110 and the secondary fluid valve 108, which facilitates deflating the inflatable structure 102, as will be discussed in greater detail below.

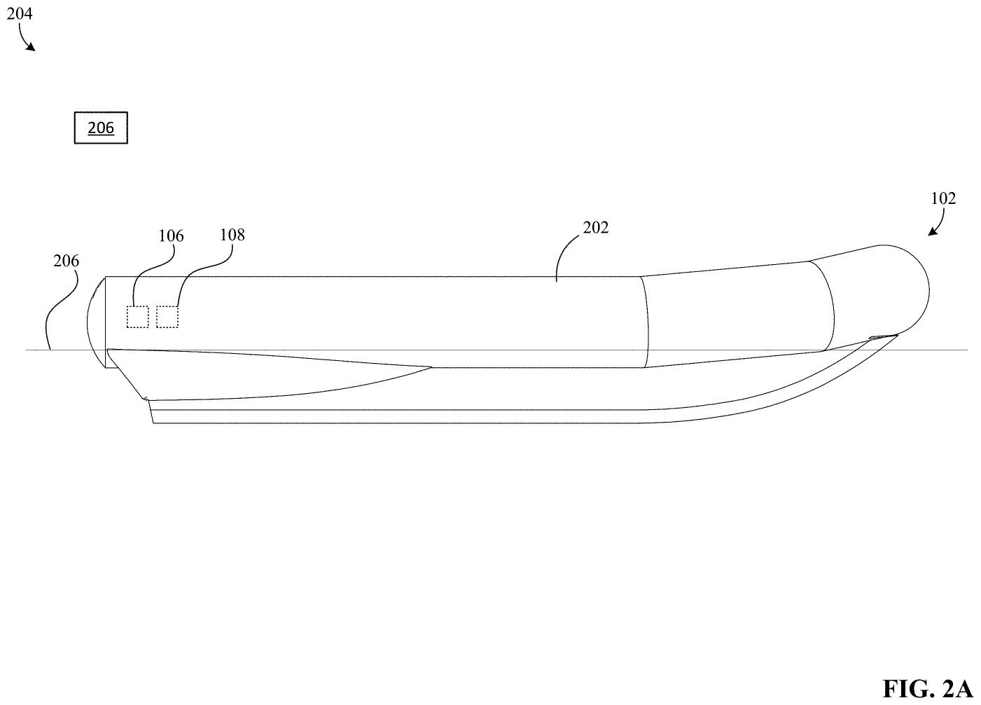

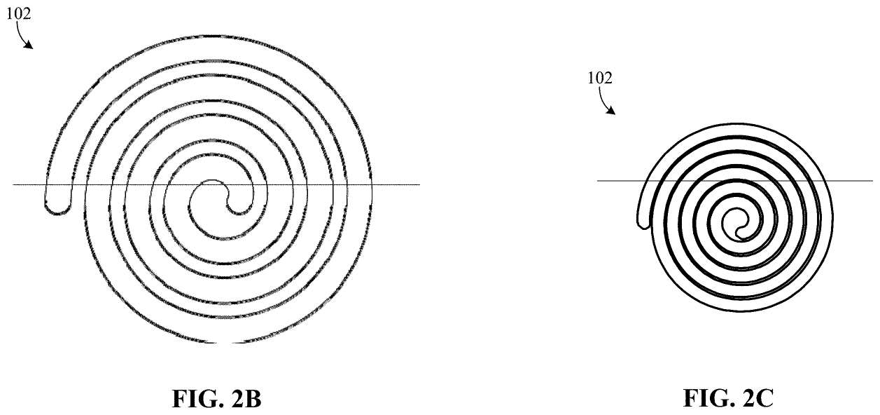

In the example of FIG. 1, the inflatable structure 102 is inflatable and/or configured to inflate. Additionally or alternatively, the inflatable structure 102 of FIG. 1 is deflatable and/or configured to deflate. The inflatable structure 102 can be implemented, for example, using one of a vessel (e.g., a watercraft), a support structure, and the like, or a combination thereof. In particular, the inflatable structure 102 includes one or more fluid chambers 112 internal to the inflatable structure 102 and configured to receive a fluid (e.g., air) 114. The fluid chamber(s) 112 of FIG. 1 can be implemented, for example, using one or more drop stitch panels, one or more air chambers, one or more air cells, one or more bladders, one or more tubes, and the like, or a combination thereof. In some embodiments, the inflatable structure 102 of FIG. 1 is configured to be substantially rigid and/or buoyant when a fluid pressure in the fluid chamber(s) 112 is relatively high (e.g., see FIG. 2A). On the other hand, in some embodiments, the inflatable structure 102 of FIG. 1 is configured to be substantially malleable and/or non-buoyant when the fluid pressure in the fluid chamber(s) 112 is relatively low (e.g., see FIG. 2B), which allows for efficient and/or compact storage of the inflatable structure 102. In such embodiments, the inflatable structure 102 of FIG. 1 can be easily manipulated (e.g., rolled up and/or folded).

According to one or more disclosed examples, the fluid 114 of FIG. 1 can be implemented using one or more compressible fluids and/or one or more incompressible fluids. In some embodiments, the fluid 114 of FIG. 1 includes one or more gases (e.g., air), one or more liquids (e.g., water), any other suitable fluid(s) or a combination thereof.

Additionally, to facilitate vacuuming out the fluid 114 from the fluid chamber(s) 112, the system 100 of FIG. 1 also includes the vacuum system 110. The vacuum system 110 of FIG. 1 includes one or more fluid control devices operable to change one or more parameters (e.g., a fluid pressure, a flow rate, and the like) of the fluid 114. In some embodiments, the fluid control device(s) of the vacuum system 110 include a vacuum pump and a vacuum fluid line (e.g., a hose for a vacuum pump) 116 fluidly coupled to the vacuum pump. The vacuum fluid line 116 is sometimes referred to more generally as a low-pressure fluid line and/or a fluid line. In such embodiments, the adapter 104 of FIG. 1 is configured to fluidly couple the vacuum fluid line 116 to the secondary fluid valve 108 such that a fluid path is defined by the secondary fluid valve 108, the adapter 104, and the vacuum fluid line 116. In particular, the vacuum system 110 of FIG. 1 is configured to create or provide, via the vacuum pump, a certain negative gauge pressure (e.g., a vacuum) in the vacuum fluid line 116 and the adapter 104 during a vacuuming process of the inflatable structure 102 (sometimes referred to as a deflating process), thereby opening the secondary fluid valve 108 and pulling out or expelling the fluid 114 from the fluid chamber(s) 112. In some embodiments, the vacuum system 110 or the vacuum pump thereof can provide a substantially perfect vacuum in the vacuum fluid line 116 and the adapter 104, for example, such that an absolute fluid pressure in the vacuum fluid line 116 and the adapter 104 is about 0 pounds per square inch absolute (PSIA).

Although FIG. 1 depicts the two fluid valves 106, 108, in some embodiments, the inflatable structure 102 is implemented differently, for example, using a different valve configuration. For example, the inflatable structure 102 can include a single valve 106, 108 or one or more other valves in addition or alternatively to the valves 106, 108 shown in FIG. 1.

In the illustrated example of FIG. 1, the primary fluid valve 106 can facilitate inflating and/or deflating the inflatable structure 102. The primary fluid valve 106 of FIG. 1 is coupled to the inflatable structure 102 or a body thereof to receive support, for example, via one or more fasteners and/or one or more fastening methods or techniques. In some embodiments, the primary fluid valve 106 is implemented, for example, using one of an inflation valve, a deflation valve, and the like, or a combination thereof. In particular, the primary fluid valve 106 of FIG. 1 is fluidly coupled to one or more (e.g., all) of the fluid chamber(s) 112 and configured to control a flow of the fluid 114 into and/or out of fluid chamber(s) 112. For example, when the primary fluid valve 106 is open or in a first valve position (e.g., an open position), additional fluid 114 can be pumped into the fluid chamber(s) 112 through the primary fluid valve 106 to inflate by increasing the fluid pressure in the inflatable structure 102. Additionally, when the primary fluid valve 106 is open or in the first valve position, the fluid 114 can be expelled from the fluid chamber(s) 112 through the primary fluid valve 106 to deflate by decreasing the fluid pressure in the inflatable structure 102 and, consequently, decrease stowage size of the inflatable structure 102. On the other hand, when the primary fluid valve 106 is closed or in a second valve position (e.g., a closed position) different from the first valve position, the primary fluid valve 106 substantially prevents the fluid 114 from flowing through or across the primary fluid valve 106. Additionally, in some embodiments, an example cap 122 can be utilized to further prevent the fluid 114 from flowing through or across the primary fluid valve 106 while the primary fluid valve 106 is closed. To manually open and/or close the primary fluid valve 106, one or more users can interact with the primary fluid valve 106 or a component thereof.

In the illustrated example of FIG. 1, the secondary fluid valve 108 can facilitate controlling an operating pressure in the fluid chamber(s) 112 to prevent damage associated with excessive fluid pressure and/or sudden pressure spikes. Further, the secondary fluid valve 108 can be advantageously utilized to facilitate further deflating the inflatable structure 102 and/or vacuuming the fluid 114 out therefrom. The secondary fluid valve 108 of FIG. 1 is coupled to the inflatable structure 102 or a body thereof to receive support, for example, via one or more fasteners and/or one or more fastening methods or techniques. In some embodiments, the secondary fluid valve 108 is implemented, for example, using a safety valve such as a PRV and the like. In particular, the secondary fluid valve 108 of FIG. 1 is fluidly coupled to one or more of the fluid chamber(s) 112 and configured to control a flow of the fluid 114 out of fluid chamber(s) 112. For example, when the secondary fluid valve 108 is open or in a first valve position (e.g., an open position), the fluid 114 can be expelled from the fluid chamber(s) 112 through the secondary fluid valve 108 to decrease the fluid pressure in the inflatable structure 102. On the other hand, similar to the primary fluid valve 106, the secondary fluid valve 108 prevents the fluid 114 from flowing through or across the secondary fluid valve 108 when the secondary fluid valve 108 is closed or in a second valve position (e.g., a closed position) different from the first valve position. In contrast to the primary fluid valve 106, the secondary fluid valve 108 of FIG. 1 is not configured to allow the fluid 114 to enter the fluid chamber(s) 112 when the secondary fluid valve 108 is open.

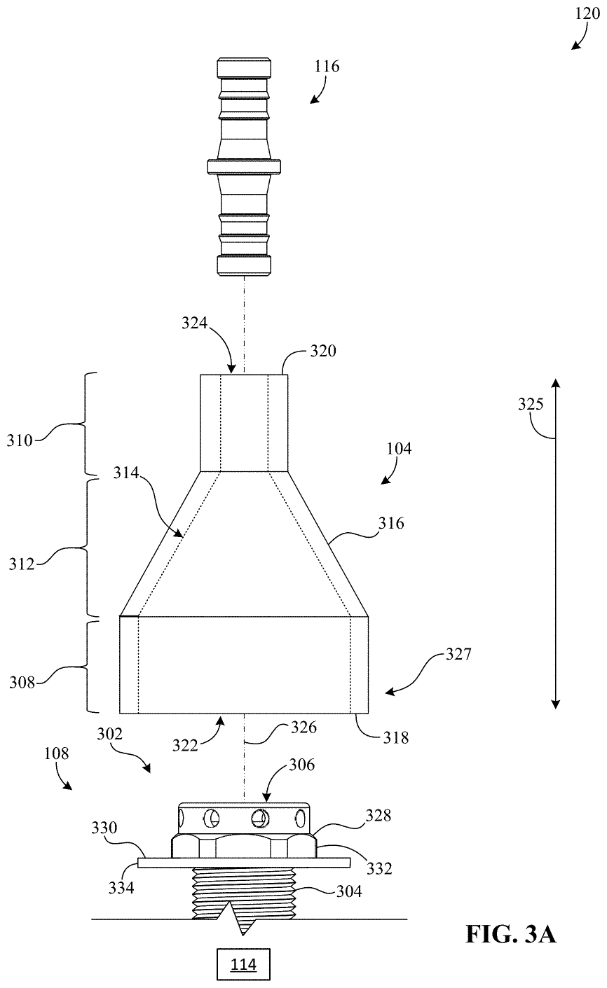

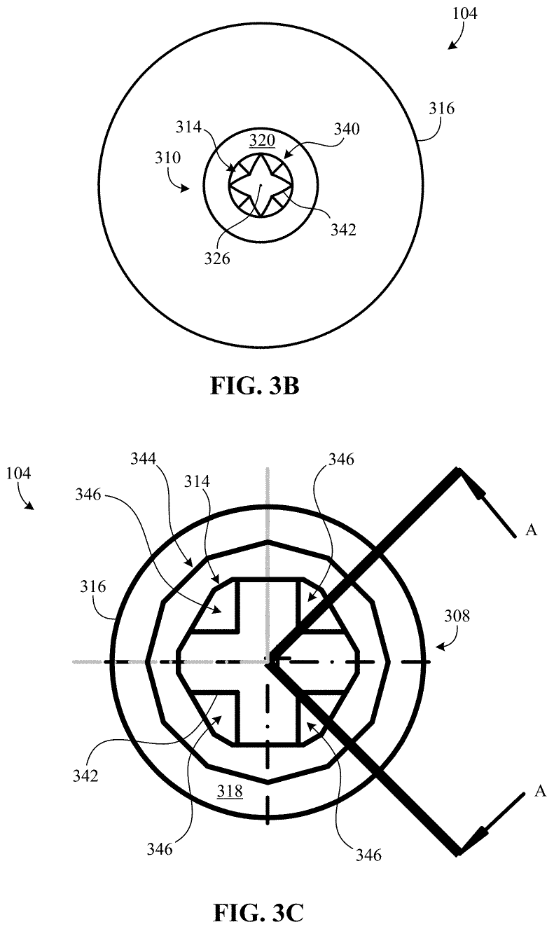

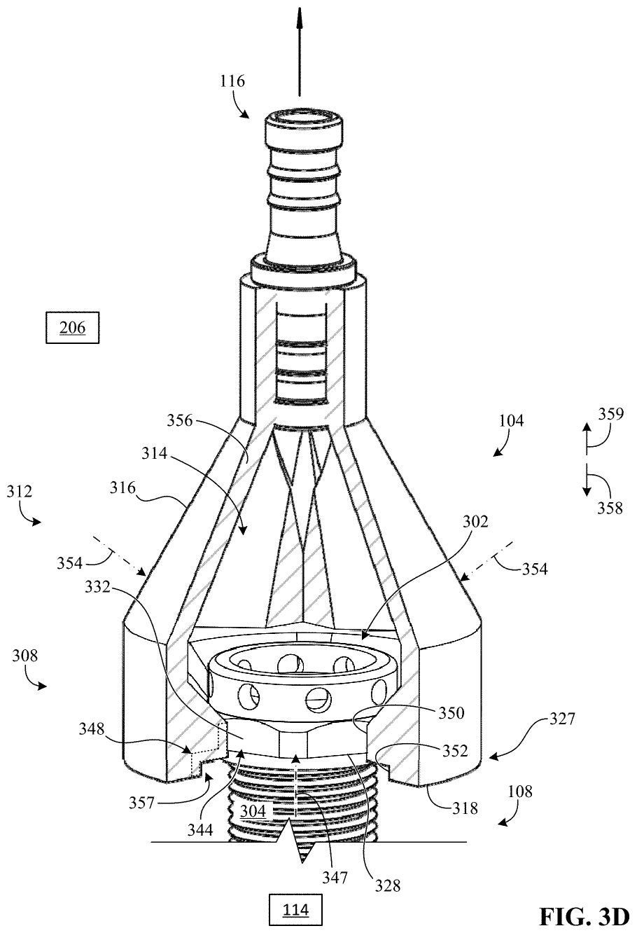

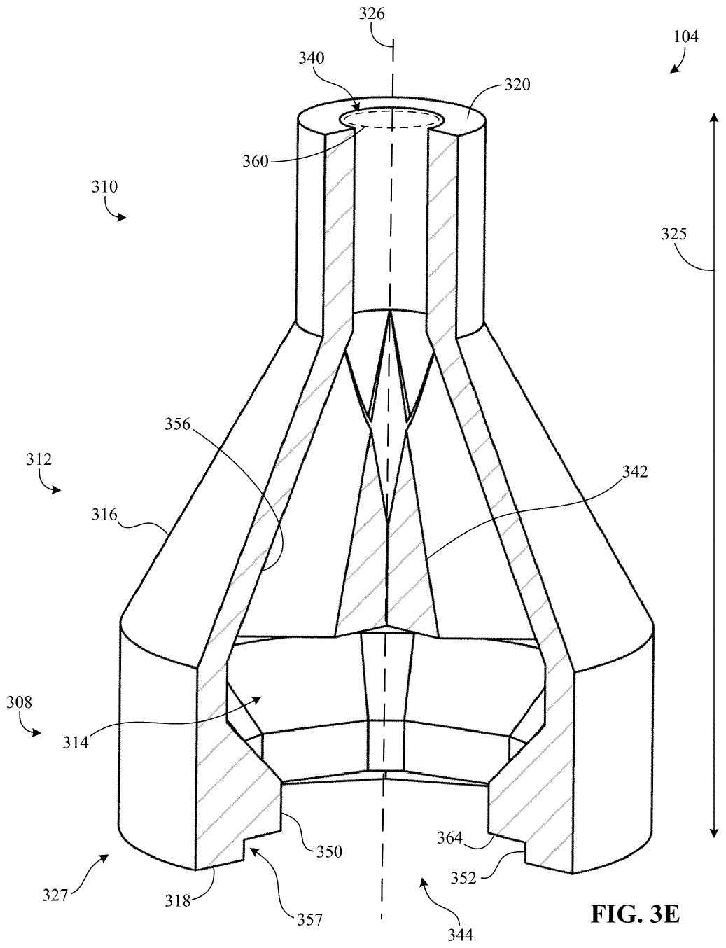

The secondary fluid valve 108 of FIG. 1 is responsive to certain pressure gradient forces. For example, the secondary fluid valve 108 of FIG. 1 can automatically open and/or close depending on a pressure gradient force (e.g., see the force 347 of FIG. 3D) applied to the secondary fluid valve 108. In some embodiments, the secondary fluid valve 108 is configured to open and/or remain open in response to the pressure gradient force exceeding a threshold or target force (e.g., a closing force associated with the secondary fluid valve 108). In particular, the secondary fluid valve 108 is also configured to close and/or remain closed in response to the pressure gradient force falling below the target force, which ensures fluid does not flow back into the fluid chamber(s) 112 through the secondary fluid valve 108 after the vacuuming process is complete. Unlike the primary fluid valve 106, the secondary fluid valve 108 can automatically close and remain closed in certain conditions to maintain the inflatable structure 102 in a desired state (e.g., a fully deflated state). The target force can be defined by an internal spring member or other mechanism of the secondary fluid valve 108 that is operatively coupled to the secondary fluid valve 108. For example, the spring member urges the secondary fluid valve 108 toward the second valve position. As such, one or more characteristics of the spring member (e.g., a spring rating) may be selected, tuned, and/or otherwise configured to provide a desired target force for the secondary fluid valve 108.

Additionally, the secondary fluid valve 108 is positioned on the inflatable structure 102 such that the secondary fluid valve 108 or part thereof is accessible to a person or user. For example, the secondary fluid valve 108 can include an outlet portion that is external to the inflatable structure 102 and can receive the vacuum adapter 104, as discussed in greater detail below.

The vacuum adapter 104 of FIG. 1 (sometimes referred to more generally as an adapter) facilitates providing a fluid connection between the secondary fluid valve 108 and the vacuum fluid line 116, as well as maintaining a certain pressure gradient across the secondary fluid valve 108 while the inflatable structure 102 is being deflated. In the example of FIG. 1, the adapter 104 is attachable (e.g., removably attachable) to the secondary fluid valve 108 and the vacuum fluid line 116. In some embodiments, the adapter 104 of FIG. 1 is provided with one or more exemplary fluid seals (e.g., mechanical seals) 118 operatively coupled thereto. In particular, when the adapter 104 is suitably positioned on the secondary valve 108 or the outlet portion thereof, each of the fluid seal(s) 118 of FIG. 1 is configured to sealingly engage the secondary fluid valve 108 or the outlet portion thereof. Such engagement substantially maintains the negative gauge pressure in vacuum adapter 104. As will be discussed in greater detail below, the fluid seal(s) 118 can be implemented using one or more parts or features of the adapter 104 such as, for example, any of an elastic portion of the adapter 104, threads of the adapter 104, and the like, or a combination thereof. Additionally or alternatively, one or more of the fluid seal(s) 118 of FIG. 1 may be suitably implemented using one or more gaskets such as rings (e.g., O-rings) that are positionable on the adapter 104 and capable of providing an airtight closure for the adapter 104 and secondary fluid valve 108.

In some embodiments, the system 100 of FIG. 1 is provided with an exemplary fluid control assembly 120 for the inflatable structure 102, which includes the adapter 104, the secondary fluid valve 108, and the vacuum fluid line 116. In such embodiments, the fluid control assembly 120 may also include the cap 122 for the primary fluid valve 106, which facilities maintaining the inflatable structure 102 in a deflated state (e.g., see FIG. 2C). The cap 122 of FIG. 1 is positionable on the primary fluid valve 106. In particular, the cap 122 of FIG. 1 is configured to couple to the primary fluid valve 102 and seal off the primary fluid valve 106 to prevent the fluid 114 from leaking back into the fluid chamber(s) 112 after the vacuuming process is complete. As such, the cap 122 is effective in keeping the primary fluid valve 106 closed. Additionally, the cap 122 can be decoupled from the primary fluid valve 106 to allow for redeployment of the inflatable structure 102.

FIGS. 2A, 2B, and 2C are detailed views of the inflatable structure 102 of FIG. 1 and show different states thereof. In FIG. 2A, the inflatable structure 102, in the exemplary form of an inflatable boat, is substantially inflated and/or in a first state (e.g., an inflated state). For example, the inflatable structure 102 is backed by the fluid pressure inside the fluid chamber(s) 112. When in the first state, the inflatable structure 102 is configured to carry and/or support a mass, such as one or more passengers. Additionally or alternatively, the inflatable structure 102 is configured to float on a liquid (e.g., water) when in the first state, where the inflatable structure 102 can provide buoyancy to the mass. According to the illustrated example of FIG. 2A, each of the primary fluid valve 106 and the secondary fluid valve 108 is positioned and/or supported on a body 202 of the inflatable structure 102, as represented by the dotted/dashed lines of FIG. 2A. In particular, each of the primary fluid valve 106 and the secondary fluid valve 108 or an outlet portion thereof is exposed to an external environment 204 that includes one or more external fluids (e.g., any of water, air, etc.) 206. Of course, it should be understood that the inflatable structure 102 can include one of more sections or chambers, with each including a separate primary fluid valve 106 and secondary fluid valve 108.

Turning in detail to FIG. 2B, the inflatable structure 102 is partially deflated and/or in a second state (e.g., a partially deflated state) different from the first state. In some embodiments, to provide the second state of the inflatable structure 102, the user(s) can open the primary fluid valve 106 and then manually roll-up the inflatable structure 102 to pull out or expel, via the primary fluid valve 106, a substantial amount of the fluid 114 from the fluid chamber(s) 112. In this manner of operating the primary fluid valve 106, the user(s) can at least partially reduce the buoyancy and the stowage size of the inflatable structure 102.

Turning in detail to FIG. 2C, the inflatable structure 102 is fully deflated and/or in a third state (e.g., a fully deflated state) different from the first and second states. In some embodiments, to provide the third state of the inflatable structure (e.g., after providing the second state), the user(s) can attach the adapter 104 to the secondary fluid valve 108 and the vacuum fluid line 116 and then activate the vacuum pump to pull out or expel an additional amount of the fluid 114 from the fluid chamber(s) 112. The additional amount of the fluid 114, when expelled via the secondary fluid valve 108, causes the pressure gradient force applied to the secondary fluid valve 108 to decrease to the target force associated with changing the position of the secondary fluid valve 108. In such embodiments (e.g., prior to activating the vacuum pump), the primary fluid valve 106 is manually is sealed off to prevent fluid from flowing across the primary fluid valve 106, for example, by coupling the cap 122 to the primary fluid valve 106. In this manner of operating the secondary fluid valve 108 in connection with the adapter 104 and the vacuum system 110, the user(s) can further reduce the buoyancy and the stowage size of the inflatable structure 102 and/or effectively maintain the inflatable structure 102 in such a state. In contrast to the illustrated example of FIG. 2B, the inflatable structure 102 of FIG. 2C is substantially more compact and less buoyant.

FIGS. 3A, 3B, 3C, 3D, 3D, and 3E are detailed views of the adapter 104 of FIG. 1 and show an implementation thereof in accordance with the teachings of this disclosure. Turning in detail to FIG. 3A, an exploded view of the fluid control assembly 120 is shown in which the adapter 104, the secondary fluid valve 108, and the vacuum fluid line 116 are separated and/or spaced from each other. The secondary fluid valve 108 of FIG. 3A includes an outlet portion 302 on which the adapter 104 is positionable. The outlet portion 302 is external to the inflatable structure 102 and/or exposed to the external environment 204 such that the outlet portion 302 is accessible to the user(s). In some embodiments, the secondary fluid valve 108 also includes a valve body 304 coupled to the outlet portion 302 and/or providing support to the outlet portion 302. As shown in FIG. 3A, the outlet portion is positioned at an end (e.g., a distal end) of the valve body 304. In particular, the outlet portion 302 defines a fluid outlet (e.g., an opening) 306 of the secondary fluid valve 108 through which the fluid 114 can be expelled from the fluid chamber(s) 112. On the other hand, the valve body 304 may define a fluid inlet of the secondary fluid valve 108 that receives the fluid 114 from the fluid chamber(s) 112. As such, the valve body 304 or part thereof may be internal to the inflatable structure 102 such that the fluid inlet of the secondary fluid valve 108 is in fluid communication with the fluid chamber(s) 112.

According to the illustrated example of FIG. 3A, the adapter 104 includes a first end portion 308, a second end portion 310, and an intermediate portion 312 coupled or connected between the first and second end portions 308, 310. The first end portion 308 is adapted to connect with the secondary fluid valve 108 of the inflatable structure 102 while the second end portion 310 is adapted to connect to with the vacuum fluid line 116 and is sometimes referred to as a neck. Further, the adapter 104 of FIG. 3A includes a vacuum chamber 314 extending through the intermediate portion 312, which is represented by the dotted/dashed lines of FIG. 3A. In particular, the vacuum chamber 314 extends through the intermediate portion 312 between the first and second end portions 308, 310 such that, when the fluid control assembly 120 is assembled, the fluid 114 is conveyable through the vacuum chamber 314 from the secondary fluid valve 108 to the vacuum fluid line 116. Further, the vacuum adapter 104 of FIG. 3A can be configured to seal off the vacuum chamber 314 together with the outlet portion 302 and the vacuum fluid line 116, for example, such none of the external fluid(s) 206 can leak into the vacuum chamber 314, as will be discussed further below.

In some embodiments, the first end portion 308, the second end portion 310, and the intermediate portion 312, together, form and/or define a body (e.g., a one-piece element) 316 of the vacuum adapter 104 configured to couple between the vacuum fluid line 116 and the secondary fluid valve 108, which is sometimes referred to as adapter body. In such embodiments, the first end portion 308 can include a first end (e.g., a proximal end) 318 of the body 316 and/or an area of the body 316 adjacent the first end 318. Further, the second end portion 310 can include a second end (e.g., a distal end) 320 of the body 316 (opposite to the first end 318) and/or an area of the body 316 adjacent the second end 320.

In the illustrated example of FIG. 3A, the body 316 of the vacuum adapter 104 is adapted to fluidly couple the vacuum fluid line 116 to the secondary fluid valve 108 of the inflatable structure 102. In some embodiments, the vacuum adapter 104 of FIG. 3A includes a fluid inlet (e.g., an aperture) 322 positioned at the first end 318 of the body 316 to receive the outlet portion 302. Further, the vacuum adapter 104 of FIG. 3A also includes a fluid outlet (e.g., an aperture) 324 positioned at the second end 320 of the body 316 to receive the vacuum fluid line 116. In such embodiments, the vacuum chamber 314 is internal to the body 316 and in fluid communication with the fluid inlet 322 and the fluid outlet 324. For example, the fluid 114 can flow (a) into the vacuum chamber 314 via fluid inlet 322 and (b) out of the vacuum chamber 314 via the fluid outlet 324. As shown in FIG. 3A, the vacuum chamber 314 extends through the adapter body 316 or a central area thereof from the fluid inlet 322 to the fluid outlet 324. The vacuum chamber 314 of FIG. 3A can extend along an axis 326 partially or entirely across a length 325 corresponding to the adapter body 316 and/or the adapter 104.

The vacuum adapter 104 and/or the body 316 thereof can be constructed of one or more materials having suitable materials properties such as, for example, one or more plastics, one or more metals, one or more composites, and the like, or a combination thereof. In some embodiments, the vacuum adapter 104 or at least part thereof (e.g., one or more of the first end portion 308, the second end portion 310, and/or the intermediate portion 312) is constructed of an elastic material such as, for example, TPU. For example, the first end portion 308 of the vacuum adapter 104 has an elastic section 327 that includes the elastic material, which enables the vacuum adapter 104 to (a) form an advantageous seal together with the outlet portion 302 and/or (b) removably attach to the outlet portion 302, as discussed further below. Accordingly, the elastic section 327 is elastic and/or flexible, for example, such that the first end portion 308 or part thereof can substantially expand and/or contract.

In some embodiments, the outlet portion 302 includes one or more flanges (e.g., radial flanges) 328, 330 positioned at or near the end of the valve body 304, two of which are shown in this example (i.e., a first flange 328 and a second flange 330). Each of the flange(s) 328, 330 of FIG. 3A can be coupled to the valve body 304, for example, via one or more fasteners and/or one more fastening methods or technique. The first flange 328 extends radially outward relative to the axis 326, which provides an outer surface 332 of the first flange 328 that is receivable by the first end portion 308 of the vacuum adapter 104. The outer surface 332 of the first flange 328 faces radially outward relative to the axis 326 and is continuous around the axis 326. Similarly, the second flange 330 extends radially outward relative to the axis 326, which provides an outer surface 334 of the second flange 330 that is receivable by the first end portion 308. As shown in FIG. 3A, the second flange 330 is adjacent the first flange 328 and can extend further away from the valve body 304 relative to the first flange 328. Accordingly, in some embodiments, the outer surface 334 of the second flange 330 is separate and/or spaced from the outer surface 332 of the first flange 328. Further, the outer surface 334 of the second flange 330 faces radially outward relative to the axis 326 and is continuous around the axis 326.

In some embodiments, the second flange 330 of FIG. 3A facilitates securing the secondary fluid valve 108 to the inflatable structure 102 or the body 202 thereof. For example, the second flange 330 can include a socket configured to receive the valve body 304. The second flange 330 can fixedly couple to the inflatable structure 102 or the body 202 thereof, for example, via one or more fasteners and/or one or more fastening methods or techniques. In such embodiments, the valve body 304 is configured to screw into the socket.

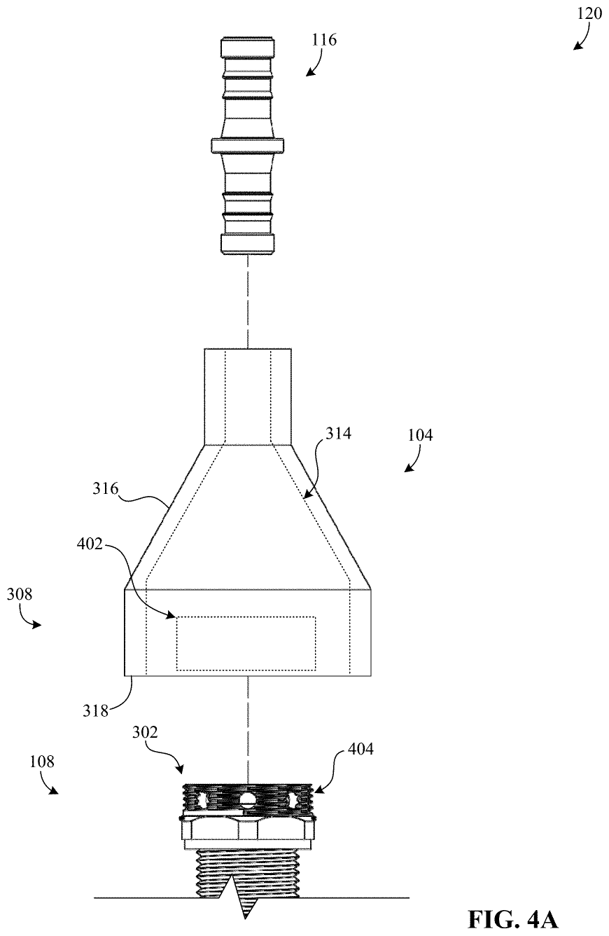

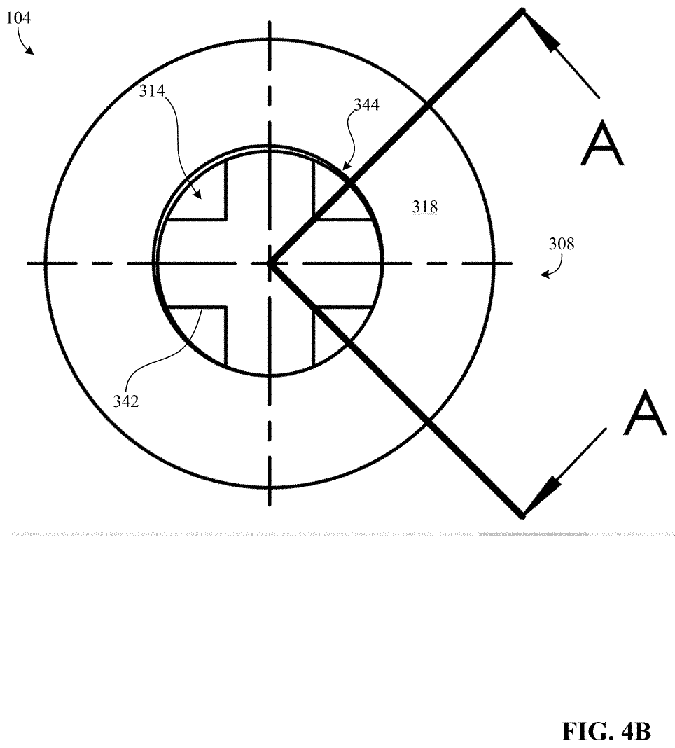

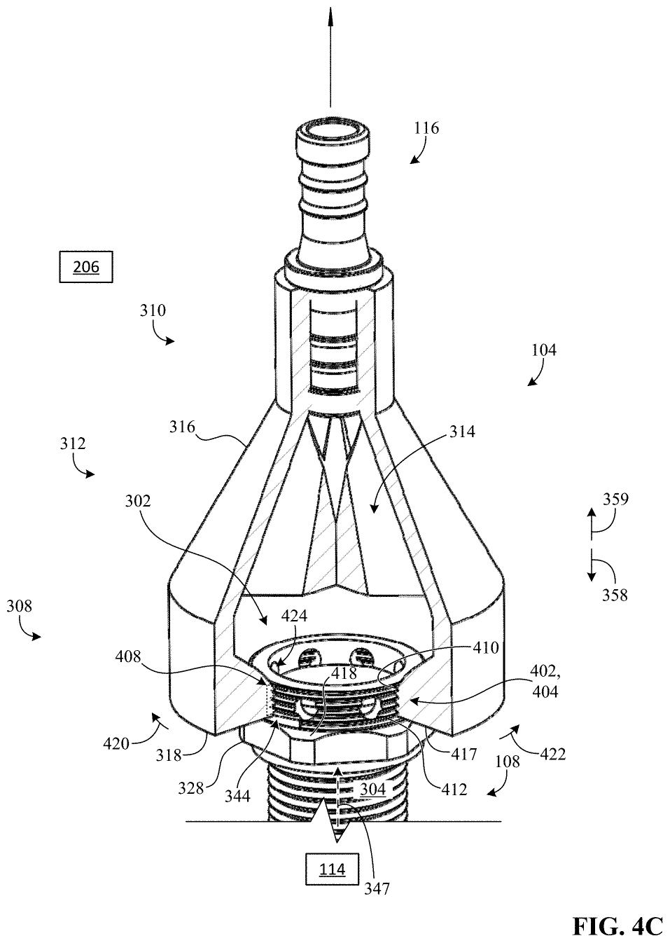

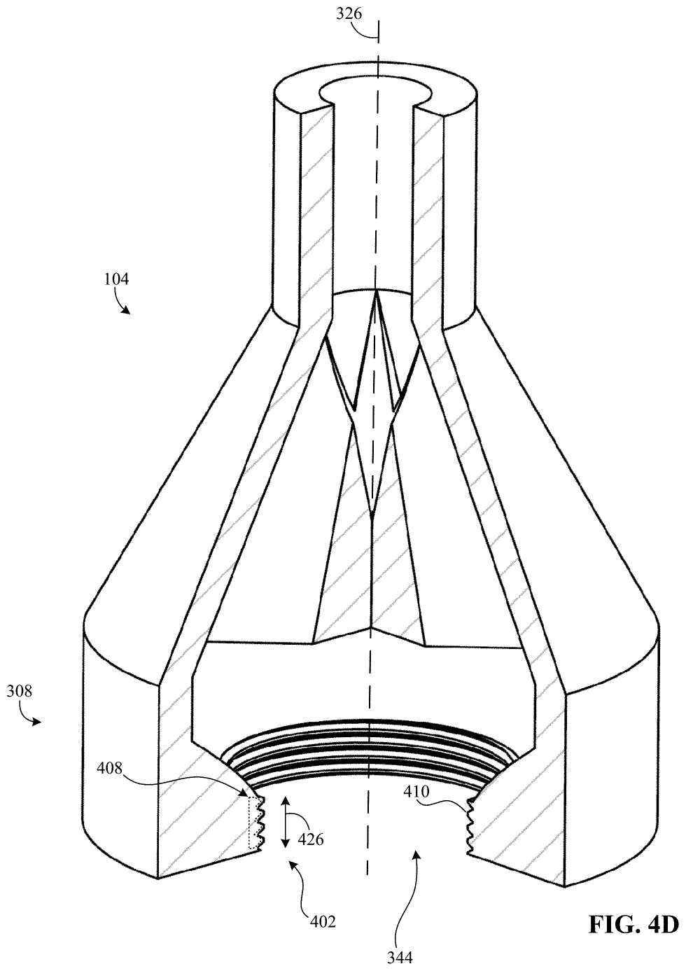

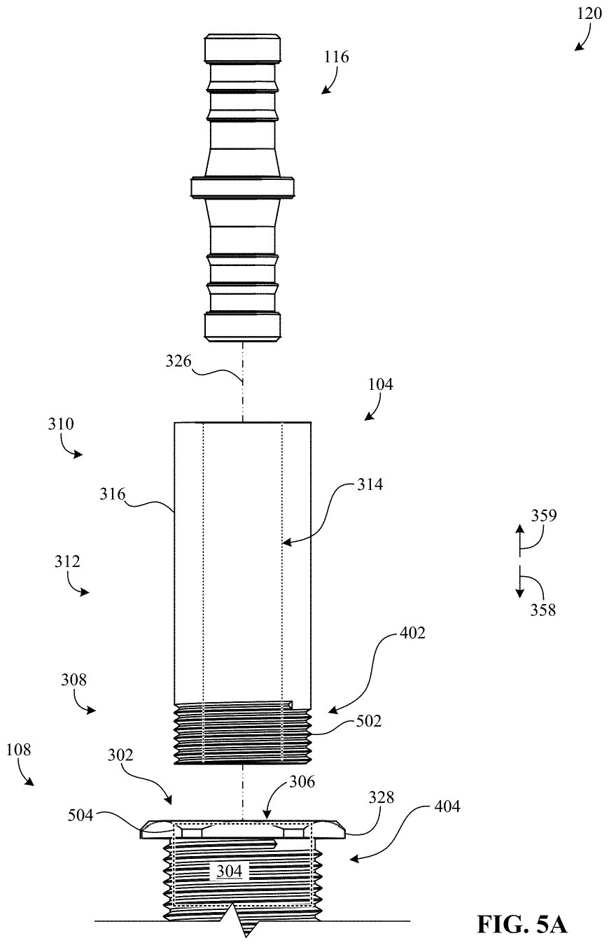

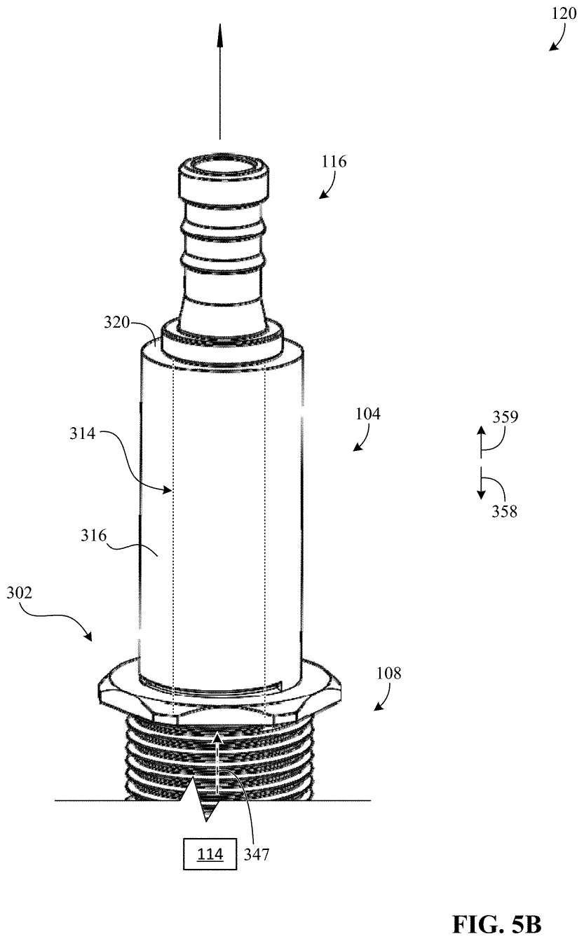

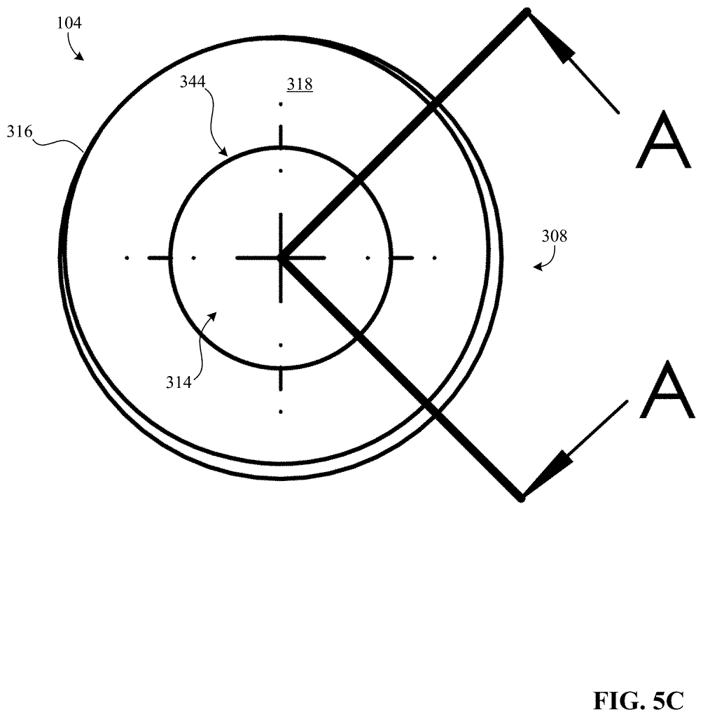

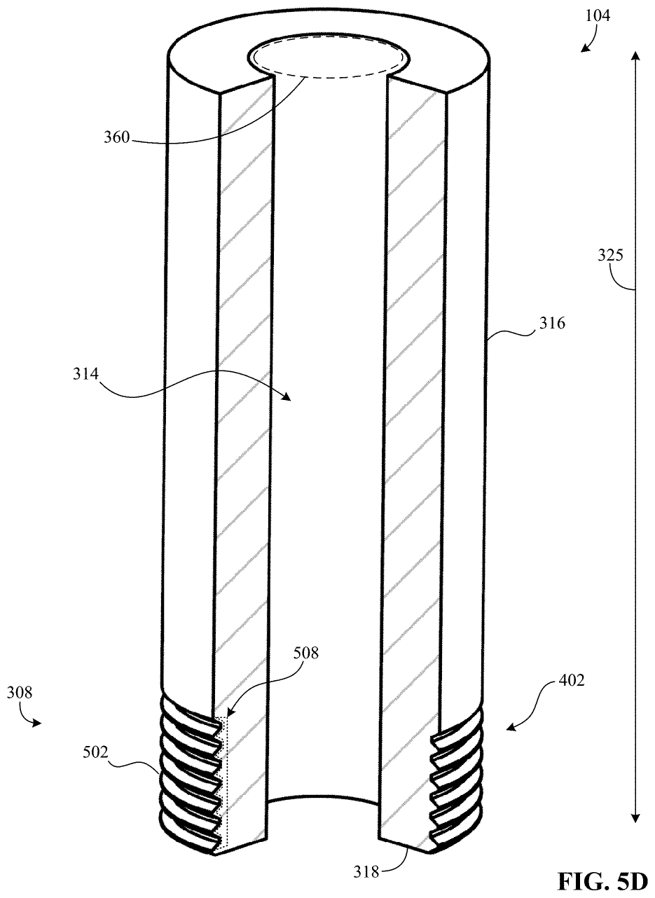

While FIG. 3A depicts the two flanges 328, 330, in some embodiments, the secondary fluid valve 108 and/or the outlet portion 302 thereof can be implemented differently (e.g., see at least FIGS. 4A and 5A).

Turning in detail to FIG. 3B, a top-view of the vacuum adapter 104 is shown. According to the illustrated example of FIG. 3B, the second end portion 310 of the body 316 defines a second aperture 340 positioned at the second end 320 of the body 316. The second aperture 340 corresponds to the fluid outlet 324 of the vacuum adapter 104. As such, the second aperture 340 is in fluid communication with the vacuum chamber 314. In some embodiments, the second aperture 340 of FIG. 3B is centrally disposed on the body 316, for example, such that the axis 326 extends through a center of the second aperture 340. Further, the second aperture 340 of FIG. 3B exposes the vacuum chamber 314 and, in some embodiments, at least part of an internal support structure 342 positioned in the vacuum chamber 314. In such embodiments, the vacuum adapter 104 includes the internal support structure 342, which effectively prevents the vacuum chamber 314 and/or the adapter body 316 from collapsing when the fluid pressure in the vacuum chamber 314 is relatively low, as discussed further below. The second aperture 340 of FIG. 3B can be particularly sized and/or shaped to receive the vacuum fluid line 116. That is, the vacuum fluid line 116 or an end portion thereof can be inserted in the second aperture 340

Turning in detail to FIG. 3C, a bottom-view of the vacuum adapter 104 is shown. According to the illustrated example of FIG. 3C, the first end portion 308 defines a first aperture 344 positioned at the first end 318 of the body 316. The first aperture 344 of FIG. 3D corresponds to the fluid inlet 322 of the vacuum adapter 104. As such, the first aperture 344 is in fluid communication with the vacuum chamber 314. As will be discussed further below, the first aperture 344 can be particularly sized and/or shaped to receive the first flange 328, the second flange 330, and/or, more generally, the outlet portion 302 of the secondary fluid valve 108. That is, any of the first flange 328, the second flange 330, and/or the outlet portion 302 can be inserted in the first aperture 344.

As shown in FIG. 3C, the first aperture 344 is centrally disposed on the body 316, for example, such that the axis 326 extends through a center of the first aperture 344. Further, the first aperture 344 of FIG. 3C exposes the vacuum chamber 314 and at least part of the internal support structure 342. In some embodiments, the vacuum chamber 314 includes a plurality of the fluid channels 346 through which the fluid 114 passes. According to the illustrated example of FIG. 3C, the plurality of fluid channels 346 is defined by the internal support structure 342 and radially distributed relative to the axis 326. Further, as shown in FIG. 3C, the internal support structure 342 or a cross-sectional area thereof is substantially X-shaped. However, in some embodiments, the internal support structure 342 or the cross-sectional area thereof can be shaped differently while still sufficiently maintaining associated functionality.

Turning in detail to FIG. 3D, a partial cross-sectional view of the vacuum adapter 104 taken along cutting-plane lines A-A of FIG. 3C is shown. According to the illustrated example of FIG. 3D, the vacuum adapter 104, the secondary fluid valve 108, and the vacuum fluid line 116 are assembled. Further, the vacuum pump of the vacuum system 110 is activated to decrease a fluid pressure in the vacuum fluid line 116 and the vacuum chamber 314 (i.e., in a space outside of or external to the secondary fluid valve 108). In particular, the vacuum adapter 104 of FIG. 3D is engaging the outlet portion 302, thereby forming a seal or tight closure around the outlet portion 302 that maintains a certain negative gauge pressure (e.g., a vacuum) in the vacuum chamber 314 causing the secondary fluid valve 108 to open for a first time interval. Stated differently, the vacuum adapter 104 of FIG. 3D is configured to engage the outlet portion 302 to form such a seal or tight closure.

In the illustrated example of FIG. 3D, a pressure gradient force 347 exerted on or applied to the secondary fluid valve 108 is defined by (a) a fluid pressure internal to secondary fluid valve 108 (e.g., the fluid pressure in the inflatable structure 102 or the chamber(s) 112 thereof) and (b) a fluid pressure external to the secondary fluid valve 108 (e.g., the negative gauge pressure in the vacuum chamber 314). In some embodiments, when the vacuum system 110 or the vacuum pump thereof creates the negative gauge pressure in the vacuum chamber 314 of FIG. 3D, the pressure gradient force 347 is initially above the target force associated with changing the position the secondary fluid valve 108 and remains above the target force for the first time interval during which the pressure gradient force 347 decreases and/or approaches the target force. In such embodiments, the adapter 104 of FIG. 3D enables the secondary fluid valve 108 to remain substantially open during the vacuuming process, for example, until (a) a certain low fluid pressure in the inflatable structure 102 is reached, (b) the adapter 104 is detached from the secondary fluid valve 108, or (c) the vacuum pump is deactivated.

In some embodiments, to facilitate the formation of the seal or tight closure around the outlet portion 302 of FIG. 3D, the vacuum adapter 104 includes a first fluid seal (e.g., a mechanical seal) 348 operatively coupled to the adapter body 316, which can correspond to and/or be used to implement any one or more of the fluid seal(s) 118 shown in FIG. 1. The first fluid seal 348 is represented by the dotted/dashed lines of FIG. 3D. The first fluid seal 348 is positioned on the first end portion 308, for example, at or adjacent the first end 318 of the body 316. In such embodiments, the first fluid seal 348 is configured to engage the outlet portion 302 to maintain the negative gauge pressure in the vacuum chamber 314 that causes the secondary fluid valve 108 to open during the vacuuming process. For example, such engagement of the first fluid seal 348 and the outlet portion 302 can maintain the fluid pressure in the vacuum chamber 314 at or below a target fluid pressure (e.g., an absolute pressure of about 0 PSIA). In some embodiments, when a substantially perfect vacuum exists in the vacuum chamber 314, the first fluid seal 348 and the outlet portion 302, together, hermetically seal off part the vacuum chamber 314 to prevent the external fluid(s) 206 from flowing between the first fluid seal 348 and the outlet portion 302 (i.e., leaking into the vacuum chamber 314).

In some embodiments, the first end portion 308 is adapted to removably attach to the outlet portion 302. In such embodiments, the first fluid seal 348 includes the elastic section 327 of the first end portion 308. According to the illustrated example of FIG. 3D, the elastic section 327 defines the first aperture 344 in which the outlet portion 302 is insertable. In particular, the first aperture 344 or an area thereof is smaller than the outlet portion 302 such that, when the outlet portion 302 is inserted in the first aperture 344, the elastic section 327 expands around the outlet portion 302. For example, a first inner surface 350 of the elastic section 327 of FIG. 3D is tightly pressed against and/or gripping the outer surface 332 of the first flange 328 as a result of such expansion. The first inner surface 350 of the elastic section 327 faces radially inward and/or toward the outer surface 332 of the first flange 328. Additionally, geometry of the first end portion 308 can substantially match geometry of the outlet portion 302. For example, the elastic section 327 can be shaped such that the first inner surface 350 and the outer surface 332 of the first flange 328 are complimentary to form an airtight seal. In some embodiments, the first flange 328 has a first contour provided by the outer surface 332 of the first flange 328, and the first aperture 344 has a second contour provided by the first inner surface 350 of the elastic section 327. In such embodiments, the elastic section 327 is configured such that a shape (e.g., a geometric shape such as one of a circle, a polygon that is regular or irregular, and the like) of the second contour matches a shape of the first contour.

Additionally or alternatively, a second inner surface (e.g., an inner circumferential surface) 352 of the elastic section 327 can tightly press against and/or grip the outer surface 334 of the second flange 330 as a result of the elastic section 327 expanding, similar to the first inner surface 350 and the first flange 328. As shown in FIG. 3D, the second inner surface 352 of the elastic section 327 faces radially inward and/or toward the valve body 304. Further, the second inner surface 352 of the elastic section 327 is separate and/or spaced from the first inner surface 350 of the elastic section 327. In some embodiments, the elastic section 327 can be shaped such that the second inner surface 352 and the outer surface 334 of the second flange 330 are complementary to form an additional air tight seal. In such embodiments, the second flange 330 has a third contour provided by the outer surface 334 of the second flange 330, and the first aperture 344 has a fourth contour provided by the second inner surface 352 of the elastic section 327. In particular, the elastic section 327 can be configured such that a shape (e.g., a geometric shape such as one of a circle, a polygon that is regular or irregular, and the like) of the fourth contour matches a shape of the third contour.

Thus, in some embodiments, the first inner surface 350 of FIG. 3D can serve as a primary valve seal, and the second inner surface 352 of FIG. 3D can serve as a secondary valve seal. In such embodiments, the first fluid seal 348 includes a double (or dual) seal. Further, each of the first inner surface 350 of the elastic section 327, the second inner surface 352 of the elastic section 327, the outer surface 332 of the first flange 328, and the outer surface 334 of the second flange 330 is sometimes referred to as a sealing surface.

In the illustrated example of FIG. 3D, one or more pressure gradient force(s) 354 are exerted on or applied to the adapter body 316 or the intermediate portion 312 resulting from the negative gauge pressure in the vacuum chamber 314. For example, such pressure gradient force(s) 354 is/are defined by (a) the negative gauge pressure in the vacuum chamber 314 and a fluid pressure external to the vacuum chamber 314 (e.g., a fluid pressure of the external fluid(s) 206). The pressure gradient force(s) 354 of FIG. 3D can urge an inner wall 356 of the intermediate portion 312 toward the axis 326 or a central area of the vacuum chamber 314. In particular, the adapter 104 can be structured and/or configured to effectively counteract the pressure gradient force(s) 354 such that a flow area (e.g., see the area 360 of FIG. 3E) of the vacuum chamber 314 is substantially maintained, as discussed further below.

To attach the adapter 104 of FIG. 3D to the secondary fluid valve 108, a user can first manually position the adapter 104 on the outlet portion 302 of the secondary fluid valve 108, for example, such that (a) the first flange 328 passes into the first aperture 344 and/or (b) the second flange 330 passes into a groove 357 on the first end 318 of the adapter body 316. Then, in some embodiments, the user can apply a certain force (e.g., having a component directed toward the secondary fluid valve 108) to the adapter 104, thereby urging (a) the first flange 328 deeper into the first aperture 344 and/or (b) the second flange 330 deeper into the groove 357. In such embodiments, as the adapter 104 of FIG. 3D moves relative to the outlet portion 302 in a first linear direction 358, the first inner surface 350 of the elastic section 327 slides tightly against the outer surface 332 of the first flange 328, and/or the second inner surface 352 of the elastic section 327 slides tightly against the outer surface 334 of the second flange 330. The adapter 104 of FIG. 3D can be manually moved or adjusted in such a manner until the adapter 104 reaches a certain position in which the seal or tight closure is sufficiently or completely formed around the outlet portion 302. Additionally, frictional forces generated by the sealing surfaces 332, 334, 350, 352 keep the adapter 104 secured to the outlet portion 302, for example, until a certain force is applied to the adapter 104 by a user.

In some embodiments, to detach the adapter 104 of FIG. 3D from the secondary fluid valve 108, a user can apply a different or opposite force (e.g., having a component directed away from the secondary fluid valve 108) to the adapter 104, thereby urging (a) the first flange 328 out of the first aperture 344 and/or (b) the second flange 330 out of the groove 357. In such embodiments, the adapter 104 of FIG. 3D can be moved relative to the outlet portion 302 in a second linear direction 359 opposite to the first linear direction 358, for example, until (a) the first inner surface 350 of the elastic section 327 disengages and/or separates from the outer surface 332 of the first flange 328 and/or (b) the second inner surface 352 of the elastic section 327 disengages and/or separates from the outer surface 334 of the second flange 330.

Turning in detail to FIG. 3E, another partial cross-sectional view of the vacuum adapter 104 taken along cutting-plane lines A-A of FIG. 3C is shown. According to the illustrated example of FIG. 3E, a flow area 360 of the vacuum chamber 314 (as represented by the dotted/dashed lines of FIG. 3E) varies along the length 325 of the vacuum adapter 104. As shown in FIG. 3E, the flow area 360 of vacuum chamber 314 is substantially larger in the first end portion 308 relative to second end portion 310. However, in some embodiments (e.g., where the outlet portion 302 of the secondary fluid valve 108 is smaller than an inlet portion of the vacuum fluid line 116), the flow area 360 can be substantially larger in the second end portion 310 relative to the first end portion 308. Further, the flow area 360 may decrease across the intermediate portion 312 from the first end portion 308 to the second end portion 310 or vice versa. The flow area 360 of FIG. 3E can correspond to any transverse cross-sectional area (i.e., an area perpendicular to the axis 326) of the vacuum chamber 314 that is between the first and second ends 318, 320 of the body 316.

In the illustrated example of FIG. 3E, the internal support structure 342 is coupled to the inner wall 356 of the intermediate portion 312, for example, via one or more fasteners and/or one or more fastening methods or techniques. In particular, the internal support structure 342 of FIG. 3E is providing support the inner wall 356 to resist one or more (e.g., all) of the pressure gradient forces 354 that act on the intermediate portion 312 when the negative gauge pressure is created in the vacuum chamber 314. As shown in FIG. 3D, the internal support structure 342 extends through the vacuum chamber 314 along the axis 326 across a length of the vacuum chamber 314 or part of the length corresponding to the intermediate portion 312.

In addition or alternatively to the internal support structure 342, certain modifications can be made to the second end portion 310 to increase strength or rigidity of the adapter 104. In some embodiments, the second end portion 310 can be shortened. In particular, in such embodiments, a distance between the vacuum fluid line 116 and the outlet portion 302 is small enough such that the adapter 104 is prevented from collapsing in on itself when the negative gauge pressure is created in the vacuum chamber 314.

In the illustrated example of FIG. 3E, the first aperture 344 extends axially through the elastic section 327 along the axis 326 from the first end 318 of the body 316 to the vacuum chamber 314. As previously described, the first flange 328 of the outlet portion 302 can be inserted in the first aperture 344 such that the first inner surface 350 of the elastic section 327 expands around the outer surface 332 of the first flange 328. Further, the second aperture 340 of FIG. 3E extends axially through the second end portion 310 along the axis 326 from the second end 320 of the body 316 to the vacuum chamber 314. As previously described, the vacuum fluid line 116 or an end portion thereof can be inserted in the second aperture 340.

Additionally or alternatively, in some embodiments, the vacuum adapter 104 includes the groove 357, which is centrally disposed on the first end 318 of the body 316 and is continuous around the axis 326. The groove 357 of FIG. 3E can correspond to part of the first aperture 344. In such embodiments, the groove 357 can be formed and/or defined by the second inner surface 352 of the elastic section 327 and a third inner surface (e.g., an annular surface or face) 364 of the elastic section 327 adjacent the second inner surface 352. As shown in FIG. 3E, the second and third inner surfaces 352, 364 of the elastic section 327 are substantially angled and/or perpendicular relative to the each other. Further, in such embodiments, the groove 357 extends though the elastic section 327 radially outward relative to the axis 326. In particular, the groove 357 of FIG. 3E is configured to receive a flange of the outlet portion 302 such as, for example, the second flange 330, as previously described. In some embodiments, the second flange 330 of the outlet portion 302 can be inserted in the groove 357 such that the second inner surface 352 expands around the outer surface 334 of the second flange 330. As a result of such insertion, (a) the second inner surface 352 of the elastic section 327 can directly contact the outer surface 334 of the second flange 330 and/or (b) the third inner surface 364 can directly contact a different surface (e.g., annular surface or face) of the second flange 330.

As shown in FIG. 3E, the intermediate portion 312 is conically-shaped. Further, each of the first and second end portions 308, 310 of FIG. 3E is cylindrically-shaped. In some embodiments, the adapter 104 can be integrally formed (molded) as a single piece. While FIGS. 3A, 3B, 3C, 3D, and 3E depicts the adapter body 316 that is particularly sized and/or shaped, in some embodiments, the adapter 104 is implemented differently.

FIGS. 4A, 4B, 4C, and 4D are other detailed views of the adapter 104 of FIG. 1 and show an additional implementation thereof in accordance with the teachings of this disclosure. Turning in detail to FIG. 4A, an exploded view of the fluid control assembly 120 is shown in which the adapter 104, the secondary fluid valve 108, and the vacuum fluid line 116 are separated and/or spaced from each other. According to the illustrated example of FIG. 4A, the body 316 of the vacuum adapter 104 is adapted to fluidly couple the vacuum fluid line 116 to the secondary fluid valve 108 of the inflatable structure 102, as previously described.

In particular, the vacuum adapter 104 of FIG. 4A includes a first threaded connection 402 (as represented by the dotted/dashed lines of FIG. 4A), which facilitates coupling and/or sealing functionality. The first threaded connection 402 of FIG. 4A is positioned on the first end portion 308, for example, at or adjacent the first end 318 of the body 316. The first threaded connection 402 can be implemented, for example, using internal threads and/or external threads. According to the illustrated example of FIG. 4A, the first threaded connection 402 is internal to vacuum adapter 104. However, in some embodiments, the first threaded connection 402 can be positioned differently relative to the vacuum adapter 104, as discussed further below in connection with FIGS. 5A, 5B, 5C, and 5D. In any case, the first threaded connection 402 of the adapter 104 is configured to threadably engage or interact with a second threaded connection 404 of the secondary fluid valve 108, thereby attaching (e.g., removably attaching) the adapter 104 to the outlet portion 302 and/or forming the aforementioned seal or tight closure around the outlet portion 302.

Turning in detail to FIG. 4B, another bottom-view of the vacuum adapter 104 is shown. Similar to the illustrated example of FIG. 3C, the first end portion 308 of FIG. 4C defines the first aperture 344, which is positioned at the first end 318 of the body 316 and exposes the vacuum chamber 314 and/or the internal support structure 342.

Turning in detail to FIG. 4C, a partial cross-sectional view of the vacuum adapter 104 taken along cutting-plane lines A-A of FIG. 4B is shown. According to the illustrated example of FIG. 4C, the vacuum adapter 104, the secondary fluid valve 108, and the vacuum fluid line 116 are assembled. Further, the vacuum pump of the vacuum system 110 is activated to decrease the fluid pressure in the vacuum fluid line 116 and the vacuum chamber 314 (i.e., in the space outside of or external to the secondary fluid valve 108). The vacuum chamber 314 of FIG. 4C is extending through the intermediate portion 312 between the first and second end portions 308, 310 such that the fluid 114 is conveyable through the vacuum chamber 314 from the secondary fluid valve 108 to the vacuum fluid line 116 while the secondary fluid valve 108 is open. In particular, the vacuum adapter 104 of FIG. 4C is engaging the outlet portion 302 to form an additional seal or tight closure around the outlet portion 302 that maintains a certain negative gauge pressure in the vacuum chamber 314 causing the secondary fluid valve 108 to open for a second time interval.

According to the illustrated example of FIG. 4C, the pressure gradient force 347 is being exerted on or applied to the secondary fluid valve 108. In some embodiments, when the negative gauge pressure is created in the vacuum chamber 314 of FIG. 4C, the pressure gradient force 347 is initially above the target force associated with changing the position of the secondary fluid valve 108 and remains above the target force for the second time interval during which the pressure gradient force 347 decreases and/or approaches the target force. In such embodiments, the adapter 104 of FIG. 4C enables the secondary fluid valve 108 to remain substantially open during the vacuuming process, for example, until (a) a certain low fluid pressure in the inflatable structure 102 is reached, (b) the adapter 104 is detached from the secondary fluid valve 108, or (c) the vacuum pump is deactivated.

In some embodiments, to facilitate the formation of the additional seal or tight closure around the outlet portion 302 of FIG. 4C, the vacuum adapter 104 includes a second fluid seal (e.g., a mechanical seal) 408, which can correspond to and/or be used to implement any one or more of the fluid seal(s) 118 shown in FIG. 1. The second fluid seal 408 is represented by the dotted/dashed lines of FIG. 4C. The second fluid seal 408 can be operatively coupled to the body 316, for example, in addition or alternatively to the first fluid seal 348. The second fluid seal 408 is positioned on the first end portion 308, for example, at or adjacent the first end 318 of the body 316. In such embodiments, similar to the first fluid seal 348, the second fluid seal 408 is configured to sealingly engage the outlet portion 302 to maintain the negative gauge pressure in the vacuum chamber 314 that causes the secondary fluid valve 108 to open during the vacuuming process. For example, such engagement of the second fluid seal 408 and the outlet portion 302 can maintain the fluid pressure in the vacuum chamber 314 at or below the target fluid pressure. In some embodiments, when a substantially perfect vacuum exists in the vacuum chamber 314, the second fluid seal 408 and the outlet portion 302, together, hermetically seal off part the vacuum chamber 314 to prevent the external fluid(s) 206 from flowing between the second fluid seal 408 and the outlet portion 302 (i.e., leaking into the vacuum chamber 314).

As previously described, in some embodiments, the first end portion 308 can be adapted to removably attach to the outlet portion 302. In such embodiments, the second fluid seal 408 can include inner threads 410 of the first threaded connection 402. The inner threads 410 of FIG. 4A are arranged internally along the first end portion 308 adjacent the first end 318 of the adapter body 316. The inner threads 410 of FIG. 4C can be coupled to the adapter body 316 or the first end portion 308 thereof, for example, via one or more fasteners and/or one or more fastening methods or techniques. In particular, the inner threads 410 of the first threaded connection 402 are receivable by outer threads 412 of the second threaded connection 404. The outer threads 412 of the second threaded connection 404 are arranged externally along the outlet portion 302 or the end of the valve body 304 adjacent the first flange 328. More particularly, the inner threads 410 are adapted to mate with the outer threads 412 such that the inner and outer threads 410, 412, together, maintain a position and/or an orientation of the adapter 104 relative to the outlet portion 302 until a certain torque is applied to the adapter 104. When the inner and outer threads 410, 412 of FIG. 4C are mated, rotation of adapter 104 relative to the secondary fluid valve 108 causes the adapter 104 to move along the axis 326 in the first linear direction 358 and/or the second linear direction 359. Additionally, the inner threads 410 of FIG. 4C can be complimentary to the outer threads 412 to form an airtight seal.

Additionally or alternatively, the second fluid seal 408 can include a face (e.g., an annular surface) 417 of the adapter body 316 positioned at the first end 318 thereof. For example, the face 417 of the adapter body 316 can be pressed tightly against a face (e.g., an annular surface) 418 of the first flange 328. In some embodiments, each of the faces 417, 418 of FIG. 4C can include a relatively flat and/or smooth surface that is continuous around the first aperture 344 and extends radially outward relative to the axis 326.

To attach the adapter 104 of FIG. 4C to the secondary fluid valve 108, a user can first manually position the adapter 104 on the outlet portion 302 of the secondary fluid valve 108, for example, such that at least part of the outlet portion 302 passes into the first aperture 344 and the threads 410, 412 begin to engage each other. Then, in some embodiments, the user can apply a first torque to the adapter 104, thereby rotating the adapter 104 relative to the outlet portion 302 in a first rotational direction (e.g., clockwise or counterclockwise) 420. In such embodiments, as the adapter 104 rotates in the first rotational direction 420, the outer threads 412 of the second threaded connection 404 impart a force on the inner threads 410 of the first threaded connection 402 that urges the adapter 104 to move in the first linear direction 358 toward the first flange 328 and/or the face 418 on the first flange 328. In particular, the adapter 104 of FIG. 4C can be rotated in such a manner until the adapter 104 reaches a certain position in which the additional seal or tight closure is formed around the outlet portion 302.

In some embodiments, to detach the adapter 104 of FIG. 4C from the secondary fluid valve 108, a user can apply a different or second torque to the adapter 104 opposite to the first torque, thereby rotating the adapter 104 in a second rotational direction 422 opposite to the first rotational direction 420. In such embodiments, as the adapter 104 rotates in the second rotational direction 422, the outer threads 412 of FIG. 4C impart a force on the inner threads 410 that urges the adapter 104 to move in the second linear direction 359 away from the first flange 328 and/or the face 418 thereon. In particular, the adapter 104 of FIG. 4C can be rotated in such a manner until substantially all of the inner and outer threads 410, 412 disengage from each other and/or outlet portion 302 exits the first aperture 344.

As shown in FIG. 4C, one or more lock holes (e.g., circular openings) 424 can be provided on the outlet portion 302 at the outer threads 412, each of which can receive a pin or lock for keeping the secondary fluid valve 108 closed in certain applications where the adapter 104 is not used. Each of the lock hole(s) 424 is positioned on the outer threads 412 of the second threaded connection 404 and may extend entirely through the outer threads 412. In some embodiments, to ensure that none of the lock hole(s) 424 open up or expose the vacuum chamber 314 to the external environment 204, the inner threads 410 of the first threaded connection 402 engage at least some of the outer threads 412 that are adjacent the face 418 of the first flange 328 (i.e., between the first flange 328 and the locking hole(s) 424). Additionally or alternatively, the inner threads 410 of the first threaded connection 402 can be configured to completely cover the lock hole(s) 424.

Turning in detail to FIG. 4D, another partial cross-sectional view of the vacuum adapter 104 taken along cutting-plane lines A-A of FIG. 4B is shown. According to the illustrated example of FIG. 4D, the inner threads 410 of the first threaded connection 402 face radially inward and/or are continuous around the axis 326 to define the first aperture 344 or part thereof. The inner threads 410 of FIG. 4D are distributed on an inner surface of the first end portion 308 across a certain axial distance 426. In some embodiments, the axial distance 426 is substantially greater than a diameter of a largest one of the lock hole(s) 424. In such embodiments, when the adapter 104 of FIG. 4D is attached to the secondary fluid valve 108, the inner threads 410 effectively close any or all of the lock hole(s) 424 on the outlet portion 302, which prevents the fluid(s) 114, 206 from flowing through the lock hole(s) 424.

In contrast to the implementation of the adapter 104 depicted in connection with FIGS. 3A, 3B, 3C, 3D, and 3E, the adapter 104 of FIG. 4D is provided with neither the first fluid seal 348 nor the groove 357. However, in some embodiments, the adapter 104 can be provided with both the first fluid seal 348 and the second fluid seal 408 and/or one or more other such fluid seals such as, for example, the third fluid seal 508 described below.

FIGS. 5A, 5B, 5C, and 5D are other detailed views of the adapter 104 of FIG. 1 and show an additional implementation thereof in accordance with the teachings of this disclosure. Turning in detail to FIG. 5A, an exploded view of the fluid control assembly 120 is shown in which the adapter 104, the secondary fluid valve 108, and the vacuum fluid line 116 are separated and/or spaced from each other. According to the illustrated example of FIG. 5A, the first end portion 308, the second end portion 310, and the intermediate portion 312 form and/or define a cylindrical body. In other words, the adapter body 316 of FIG. 5A is cylindrically-shaped. As previously described, the body 316 of the vacuum adapter 104 is adapted to fluidly couple the vacuum fluid line 116 to the secondary fluid valve 108 of the inflatable structure 102. In the example of FIG. 5A, the first end portion 308 is adapted to connect with the secondary fluid valve 108, and the second end portion 310 is adapted to connect to with the vacuum fluid line 116. In particular, the first end portion 308 of FIG. 5A is insertable in the fluid outlet 306 of the secondary fluid valve 108 (i.e., in outlet portion 302).

The vacuum adapter 104 of FIG. 5A is provided with the first threaded connection 402, and the secondary fluid valve 108 of FIG. 5A is provided with the second threaded connection 404. In particular, the first threaded connection 402 of FIG. 5A is external to vacuum chamber 314. As previously described, the first threaded connection 402 is configured to threadably interact with the second threaded connection 404, thereby attaching (e.g., removably attaching) the adapter 104 to the outlet portion 302 and/or forming an additional seal around the outlet portion 302 that maintains the negative gauge pressure in the vacuum chamber 314.

According to the illustrated example of FIG. 5A, the first threaded connection 402 includes outer threads 502 but not the inner threads 410 previously described. The outer threads 502 of FIG. 5D are arranged externally along the first end portion 308 adjacent the first end 318 of the adapter body 316. The outer threads 502 of FIG. 5A are coupled to the adapter body 316 or the first end portion 308 thereof, for example, via one or more fasteners and/or one or more fastening methods or techniques. In particular, the outer threads 502 of the first threaded connection 402 are receivable by inner threads 504 of the second threaded connection 404. The inner threads 504 of FIG. 5D are represented by the dotted/dashed lines of FIG. 5A. Further, the inner threads 504 of FIG. 5D are arranged internally along the outlet portion 302 or the end of the valve body 304 adjacent the first flange 328. More particularly, the outer threads 502 are adapted to mate with the inner threads 504 such that the outer and inner threads 502, 504, together, maintain a position and/or an orientation of the adapter 104 relative to the outlet portion 302 until a certain torque is applied to the adapter 104. When the outer and inner threads 502, 504 of FIG. 5A are mated, rotation of the adapter 104 relative to the secondary fluid valve 108 causes the adapter 104 to move along the axis 326 in the first linear direction 358 and/or the second linear direction 359. Additionally, the outer threads 502 of FIG. 5A can be complimentary to the inner threads 504 to form an airtight seal.

To attach the adapter 104 of FIG. 5A to the secondary fluid valve 108, a user can first manually position the adapter 104 relative to the outlet portion 302 of the secondary fluid valve 108, for example, such that at least part of first end portion 308 passes into the fluid outlet 306 of the secondary fluid valve 108 and the threads 502, 504 begin to engage each other. Then, in some embodiments, the user can apply the first torque to the adapter 104, thereby rotating the adapter 104 relative to the outlet portion 302 in the first rotational direction 420. In such embodiments, as the adapter 104 rotates in the first rotational direction 420, the inner threads 504 of the second threaded connection 404 impart a force on the outer threads 502 of the first threaded connection 402 that urges the adapter 104 to move in the first linear direction 358 and/or deeper into the fluid outlet 306. In particular, the adapter 104 of FIG. 5A can be rotated in such a manner until the adapter 104 reaches a certain position in which an additional seal or tight closure is formed around the outlet portion 302.

In some embodiments, to detach the adapter 104 of FIG. 5A from the secondary fluid valve 108, a user can apply the second torque to the adapter 104, thereby rotating the adapter 104 in the second rotational direction 422. In such embodiments, as the adapter 104 rotates in the second rotational direction 422, the inner threads 504 of FIG. 5A impart a force on the outer threads 502 that urges the adapter 104 to move in the second linear direction 359 and/or out of the fluid outlet 306 of the secondary fluid valve 108. In particular, the adapter 104 of FIG. 4C can be rotated in such a manner until substantially all of the outer and inner threads 502, 504 disengage from each other and/or first end portion 308 exits the fluid outlet 306 of the secondary fluid valve 108.

Turning in detail to FIG. 5B, an assembled view of the fluid control assembly 120 is shown in which the vacuum adapter 104, the secondary fluid valve 108, and the vacuum fluid line 116 are assembled. According to the illustrated example of FIG. 5B, the vacuum pump of the vacuum system 110 is activated to decrease the fluid pressure in the vacuum fluid line 116 and the vacuum chamber 314 (i.e., in the space outside of or external to the secondary fluid valve 108). The vacuum chamber 314 of FIG. 5B is extending through the body 316 between the first and second ends 318, 320 thereof such that the fluid 114 is conveyable through the vacuum chamber 314 from the secondary fluid valve 108 to the vacuum fluid line 116 while the secondary fluid valve 108 is open. In particular, the vacuum adapter 104 of FIG. 5B is engaging the outlet portion 302 to form the additional seal or tight closure around the outlet portion 302, which maintains a certain negative gauge pressure in the vacuum chamber 314 that causes the secondary fluid valve 108 to open for a third time interval.

According to the illustrated example of FIG. 5B, the pressure gradient force 347 is being exerted on or applied to the secondary fluid valve 108. In some embodiments, when the negative gauge pressure is created in the vacuum chamber 314 of FIG. 5B, the pressure gradient force 347 is initially above the target force associated with changing the position of the secondary fluid valve 108 and remains above the target force for the third time interval during which the pressure gradient force 347 decreases and/or approaches the target force. In some embodiments, the adapter 104 of FIG. 5B enables the secondary fluid valve 108 to remain substantially open during the vacuuming process, for example, until (a) a certain low fluid pressure in the inflatable structure 102 is reached, (b) the adapter 104 is detached from the secondary fluid valve 108, or (c) the vacuum pump is deactivated.

Turning in detail to FIG. 5C, another bottom-view of the vacuum adapter 104 is shown. According to the illustrated example of FIG. 5C, the first end portion 308 of the adapter 104 defines the first aperture 344, which is positioned at the first end 318 of the adapter body 316 and exposes the vacuum chamber 314.

Turning in detail to FIG. 5D, a partial cross-sectional view of the vacuum adapter 104 taken along cutting-plane lines A-A of FIG. 5C is shown. According to the illustrated example of FIG. 5C, the flow area 360 of the vacuum chamber 314 (as represented by the dotted/dashed lines of FIG. 5C) does not vary along the length 325 of the adapter 104. As shown in FIG. 5D, the flow area 360 is substantially constant along the length 325. Further, the adapter 104 of FIG. 5D is not provided with the aforementioned internal support structure 342. Instead, to prevent the vacuum chamber 314 from imploding during the vacuuming process, the adapter body 316 of FIG. 5D is cylindrically-shaped and has a relatively thick cylindrical wall.

In some embodiments, to facilitate the formation of the additional seal or tight closure around the outlet portion 302, the vacuum adapter 104 includes a third fluid seal (e.g., a mechanical seal) 508, which can correspond to and/or be used to implement any one or more of the fluid seal(s) 118 shown in FIG. 1. The third fluid seal 508 is represented by the dotted/dashed lines of FIG. 5D and can include the outer threads 502 of the first threaded connection 402. The third fluid seal 508 can be operatively coupled to the body 316 of the adapter 104, for example, in addition or alternatively to the first fluid seal 348 and/or the second fluid seal 408. The third fluid seal 508 is positioned on the first end portion 308, for example, at or adjacent the first end 318 of the body 316. In such embodiments, similar to the first and second fluid seals 348, 408, the third fluid seal 508 is configured to sealingly engage the outlet portion 302 to maintain the negative gauge pressure in the vacuum chamber 314 that causes the secondary fluid valve 108 to open. For example, such engagement of the third fluid seal 508 and the outlet portion 302 can maintain the fluid pressure in the vacuum chamber 314 at or below the target fluid pressure. In some embodiments, when a substantially perfect vacuum exists in the vacuum chamber 314, the third fluid seal 508 and the outlet portion 302, together, hermetically seal off part the vacuum chamber 314 to prevent the external fluid(s) 206 from flowing between the first fluid seal 348 and the outlet portion 302 (i.e., leaking into the vacuum chamber 314).

As previously described, the adapter 104 of FIGS. 3A, 3B, 3C, 3D, 3E, 4A, 4B, 4C, 4D, 5A, 5B, 5C, and 5D can be provided with a single one the fluid seal(s) 118, 348, 408, 508 or a combination thereof. Additionally or alternatively, the adapter 104 is provided with means for forming an airtight seal around the outlet portion 302 of the secondary fluid valve 108. In some embodiments, the means for forming the airtight seal is the first inner surface 350 of the elastic section 327. Further, in some embodiments, the means for forming the airtight seal is the second inner surface 352 of the elastic section 327. Further still, in some embodiments, the means for forming the airtight seal is the inner threads 410 of the first threaded connection 402. Further still, in some embodiments, the means for forming the airtight seal is the outer threads 502 of the first threaded connection 402. Further still, in some embodiments, the means for forming the airtight seal is a gasket such as a ring (e.g., an O-ring). In other embodiments, the means for forming the airtight seal can be any other suitable mechanical seal or sealing element positionable on the adapter 104.

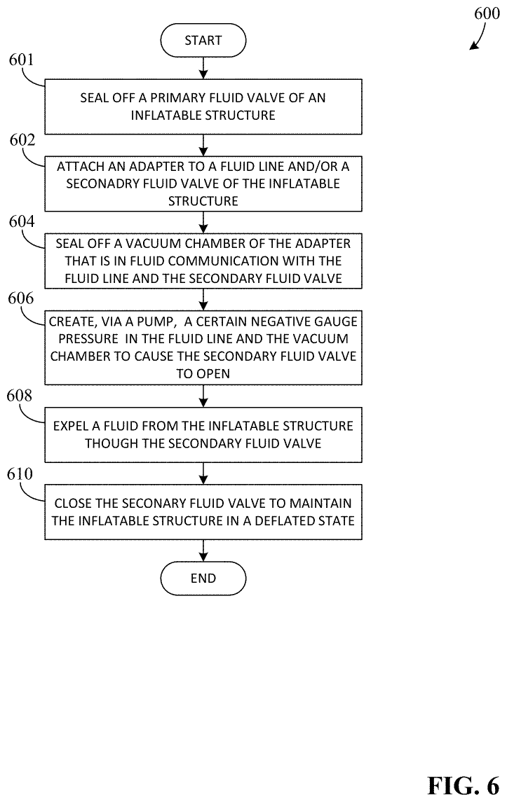

FIG. 6 is a flowchart representative of an exemplary method 600 that can be executed to implement one or more examples disclosed herein. The example method 600 of FIG. 6 can be implemented in the example system 100 of FIG. 1. In particular, the example method 600 of FIG. 6 is effective vacuuming out the fluid 114 from the inflatable structure 102 or the fluid chamber(s) 112 thereof by using the adapter 104 of FIGS. 1, 3A, 3B, 3C, 3D, 3E, 4A, 4B, 4C, 4D, 5A, 5B, 5C, and/or 5D and, in some embodiments, the secondary fluid valve 108 and the vacuum system 110 previously described.

The example method 600 of FIG. 6 begins by sealing off a primary fluid valve of an inflatable structure (block 601). In some embodiments, one or more users can seal off the primary fluid valve 106 of the inflatable structure 102, for example, by coupling the cap 122 to the primary fluid valve 106.

The example method 600 of FIG. 6 also includes attaching an adapter to a fluid line and/or a secondary fluid valve of the inflatable structure (block 602). In some embodiments, the user(s) can attach the example adapter 104 to the fluid line 116 and/or the secondary fluid valve 108 of the inflatable structure 102, for example, via the elastic section 327 and/or the first threaded connection 402 previously described in connection with the adapter 104.

The example method 600 of FIG. 6 also includes sealing off a vacuum chamber of the adapter that is in fluid communication with the fluid line and the secondary fluid valve (block 604). In some embodiments, the user(s) can seal off the example vacuum chamber 314 of the adapter 104, which is in fluid communication with the fluid line 116 and the secondary fluid valve 108. In such embodiments, the user(s) can manipulate (e.g., push, twist, and the like) the adapter 104 to urge one or more of the fluid seals 118, 348, 408, 508 into engagement with the outlet portion 302.

The example method 600 of FIG. 6 also includes creating, via a pump, a certain negative gauge pressure in the fluid line and the vacuum chamber to cause the secondary fluid valve to open (block 606). In some embodiments, the user(s) can create, via the vacuum pump of the vacuum system 110, a certain negative gauge pressure (e.g., a vacuum) in the fluid line 116 and the vacuum chamber 314 that causes the secondary fluid valve 108 to open. That is, at block 606, the user(s) may turn on or activate the vacuum pump and/or set the vacuum pump to a particular operating mode.

The example method 600 of FIG. 6 also includes expelling a fluid from the inflatable structure through the secondary fluid valve (block 608). In some embodiments, the user(s) can expel the fluid 114 from the inflatable structure 102 or the fluid chamber(s) 112 thereof through the secondary fluid valve 108. For example, at block 608, the vacuum pump of the vacuum system 110 is kept on or in an activated state. In such embodiments, the secondary fluid valve 108 remains open as a result of the adapter 104 maintaining the pressure gradient force 347 above the target force associated with changing the position of the secondary fluid valve 108.

The example method 600 of FIG. 6 also includes closing the secondary fluid valve to maintain the inflatable structure in a deflated state (block 610). In some embodiments, the user(s) can close the secondary fluid valve 108 to maintain the inflatable structure 102 in the third state (e.g., see FIG. 2C). In such embodiments, the user(s) may deactivate or turn off the vacuum pump of the vacuum system 110 or remove the adapter 104 from the secondary fluid valve 108, thereby closing the secondary fluid valve 108. Alternatively, in some embodiments, the secondary fluid valve 108 may close automatically after a certain pressure differential associated therewith is achieved (i.e., when the pressure gradient force 347 decreases to the target force).

Although the example method 600 is described in connection with the flowchart of FIG. 6, other methods of implementing the examples disclosed herein may be alternatively used. For example, the order of execution of the blocks 601, 602, 604, 606, 608, 610 may be changed, and/or some of the blocks 601, 602, 604, 606, 608, 610 described may be changed, eliminated, or combined.

As used herein, the terms “including” and “comprising” (and all forms and tenses thereof) are to be open ended terms. Thus, whenever a claim employs any form of “include” or “comprise” (e.g., comprises, includes, comprising, including, has, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended.

It will be appreciated that the apparatus, systems, and methods disclosed in the foregoing description provide numerous advantages. Although certain example apparatus, systems, and methods have been disclosed herein, the scope of coverage of this patent is not limited thereto. Obviously, numerous modifications and variations are possible in light of the above teachings. It is therefore to be understood that within the scope of the appended claims, the invention may be practiced otherwise than as specifically described herein.

What is claimed is:

1. A vacuum adapter for a relief valve of an inflatable structure, comprising:
a first end portion adapted to connect with the relief valve;
a second end portion adapted to connect with a vacuum fluid line;
an intermediate portion coupled between the first and second end portions;
a vacuum chamber extending through the intermediate portion between the first and second end portions, such that a fluid is conveyable through the vacuum chamber from the relief valve to the vacuum fluid line; and
a fluid seal positioned on the first end portion, where the fluid seal is configured to engage an outlet portion of the relief valve to maintain a negative gauge pressure in the vacuum chamber that causes the relief valve to open during a deflating process of the inflatable structure.

2. The vacuum adapter of claim 1, wherein the first end portion is adapted to removably attach to the outlet portion of the relief valve.

3. The vacuum adapter of claim 2, wherein the fluid seal includes an elastic section of the first end portion defining an aperture in which the outlet portion is insertable, the aperture being smaller than the outlet portion such that, when the outlet portion is inserted in the aperture, the elastic section expands around the outlet portion.

4. The vacuum adapter of claim 3, wherein the outlet portion includes a first flange extending radially outward relative to an axis, and wherein the elastic section is shaped such that a first inner surface of elastic section and an outer surface the first flange are complementary to form an air tight seal.

5. The vacuum adapter of claim 4, wherein the outlet portion includes a second flange adjacent the first flange and extending radially outward relative to the axis, and wherein the elastic section is shaped such that a second inner surface of the elastic section and an outer surface of the second flange are complementary to form an additional air tight seal, the second inner surface of the elastic section spaced from the first inner surface.

6. The vacuum adapter of claim 3, further including a groove extending through the elastic section radially outward relative to an axis and configured to receive a flange of the outlet portion.

7. The vacuum adapter of claim 2, further including a first threaded connection positioned on the first end portion and configured to threadably engage with a second threaded connection of the relief valve.

8. The vacuum adapter of claim 7, wherein the fluid seal includes inner threads of the first threaded connection that are arranged internally along the first end portion and receivable by outer threads of the second threaded connection arranged externally along the outlet portion.

9. The vacuum adapter of claim 7, wherein the fluid seal includes outer threads of the first threaded connection that are arranged externally along the first end portion and receivable by inner threads of the second threaded connection arranged internally along the outlet portion.

10. The vacuum adapter of claim 7, wherein threads of the first threaded connection are complimentary to threads of the second threaded connection to form an airtight seal.

11. The vacuum adapter of claim 7, wherein the first end portion, the second end portion, and the intermediate portion, together, define a body of the vacuum adapter that is cylindrically-shaped.

12. The vacuum adapter of claim 1, wherein a flow area of the vacuum chamber varies along a length of the vacuum adapter.

13. The vacuum adapter of claim 12, further including an internal support structure positioned in the vacuum chamber and coupled to an inner wall the intermediate portion, the internal support structure providing support to the inner wall to resist a pressure gradient force applied to the intermediate portion.

14. The vacuum adapter of claim 13, wherein vacuum chamber includes a plurality of fluid channels defined by the support structure and radially distributed relative to an axis.

15. The vacuum adapter of claim 14, wherein the support structure includes a cross-sectional area that is substantially X-shaped.

16. The vacuum adapter of claim 12, wherein the intermediate portion is conically-shaped, and wherein each of the first and second end portions is cylindrically-shaped.

17. A vacuum adapter, comprising:
a body configured to fluidly couple a vacuum fluid line to a fluid valve of an inflatable structure;
a fluid inlet positioned at a first end of the body to receive an outlet portion of the fluid valve that is external to the inflatable structure;
a fluid outlet positioned at a second end of the body to receive a vacuum fluid line; and
a vacuum chamber internal to the body and in fluid communication with the fluid inlet and the fluid outlet,
wherein the vacuum adapter is configured to engage the outlet portion to form a seal around the outlet portion that maintains a negative gauge pressure in the vacuum chamber causing the fluid valve to open for a time interval.

18. The vacuum adapter of claim 17, wherein the fluid valve includes a pressure relief valve, and wherein the vacuum adapter is attachable to the pressure relief valve.

19. The vacuum adapter of claim 18, wherein the body is configured to couple to the outlet portion and decouple from the outlet portion.

20. An apparatus, comprising:
a vacuum adapter configured to couple between a vacuum fluid line and a pressure relief valve of an inflatable structure, the vacuum adapter including a body that defines a vacuum chamber to convey a fluid from the pressure relief valve to the vacuum fluid line during a vacuuming process of the inflatable structure; and
means for forming an airtight seal around an outlet portion of the pressure relief valve.
